(19) United States
(12) Patent Application Publication
(10) Pub. No.: US 2025/0350210 A1
(43) Pub. Date: Nov. 13, 2025

(54) CLOSED LOOP CONTROL OF DUAL ACTIVE BRIDGES

(71) Applicant: Nanyang Technological University, Singapore (SG)

(72) Inventors: Radhika SARDA, Singapore (SG); Abishek SETHUPANDI, Singapore (SG); Madasamy PALVESHA THEVAR, Singapore (SG); Sriram VAISAMBHAYANA BRIHADEESWARA, Singapore (SG); Palani PRAVEENKUMAR, Singapore (SG); Anshuman TRIPATHI, Singapore (SG)

(21) Appl. No.: 18/660,022

(22) Filed: May 9, 2024

(51) Int. Cl. H02M 3/335; H02M 1/00

(52) U.S. Cl. CPC H02M 3/33573; H02M 1/0043; H02M 3/33584

(57) ABSTRACT

A system includes a converter that distributes electric energy from an energy source to a load. The converter includes a dual active bridge. The system includes interfaces coupled to the converter. The system also includes a controller system that includes the interfaces and a controller. The controller system includes processors that perform determining of modulation control attributes based on characteristics of the converter, the modulation control attributes including one or more modulation control parameters and one or more modulation control modes corresponding to one or more phase shift techniques, obtaining operational condition information within the converter, the operational condition information corresponding to a component within the converter or an output of the converter, iteratively adjusting the modulation control attributes based on the operational condition information and controlling the converter based on the iteratively adjusted modulation control attributes.

### TECHNICAL FIELD

This disclosure pertains to electronic controlling of operations of converters such as dual active bridges (DABs). These operations may include modulating the converters in order to control attributes of the converters such as duty cycle, phase shifts between different bridges, and/or a phase shift modulation control mode.

### BACKGROUND

Power electronics provide a newfound resiliency to the energy infrastructure. For example, power electronics transform voltages and currents from one voltage and/or shape to another, thereby efficiently supplying more flexible energy solutions. In addition, power electronics create frameworks by connecting energy sources, such as batteries and renewable energy sources like solar and wind, to other power sources such as direct current (DC) and alternating current (AC) sources. Today, seventy percent of the electrical energy supply is processed by power electronics. Power electronics have created a metamorphosis in the energy infrastructure by provisioning energy to remote areas, and converting previously polluting infrastructure into more environmentally friendly alternatives. At the same time, efforts to fully harness power electronics have encountered new challenges, such as inefficiencies resulting from losses, which include switching losses, losses due to reactive current, and other losses.

### SUMMARY

A claimed solution rooted in computer technology overcomes problems specifically arising in the realm of computer technology, in particular, to maintenance and control of an electric system, which includes a converter such as a dual active bridge (DAB). The converter includes converter circuitry that transforms and distributes energy from one or more energy sources to one or more loads that draw or consume energy. A DAB in particular provides galvanic isolation, high power density, high efficiency, symmetric structure, and bidirectional power distribution.

Currently, converters are plagued by inefficiencies. Even under theoretically ideal or efficient conditions, such as unity voltage gain, parasitic components and nonlinearities within the converter circuitry during operation result in losses and compromise efficiency of the converters. Parasitic components may include switch capacitances, drain-source on resistances (RDS-on resistances) which indicate resistances between a drain and source in a transistor, and/or parasitic inductances. Influences from parasitic components may change behavior of the converter especially under certain scenarios such as high switching frequencies, low power levels and/or high voltage levels due to exacerbated effects of non-linearities in those situations. The resulting losses include, among other losses, switching losses at switches of the converters, losses due to excess reactive current within the converters, and/or power losses at an output of the converters. The excess reactive current results in reactive power losses because the excess reactive current generates heat without performing active work.

Converters operating at different voltage ratios may have different theoretical soft switching regions with respect to a normalized output power and inductance levels, as illustrated in FIG. 11. For example, generally, lowering a voltage ratio from 1 to about 0.5 results in a higher normalized output power (e.g., a ratio between an output power and a rate of power) that is required for soft switching. Likewise, increasing a voltage ratio from 1 to about 1.4 results in a higher normalized output power required for soft switching. Theoretically, at a unity voltage gain, a converter experiences soft switching, such as zero-voltage switching (ZVS), at all power levels. However, the theoretical relationship may be inaccurate in actual practice because it disregards nonideal conditions such as parasitic components and nonlinearities.

The electric system herein described addresses these inefficiencies and confers additional benefits under different and changing operational condition information. The electric system includes a controller that maintains and controls operations of the converter in a closed loop manner in order to reduce or minimize switching losses at switches of the converter and to reduce or minimize excess reactive energy or reactive current within the converter. The controller may minimize switching losses by maintaining the switches under soft-switching conditions, such as ZVS. First, the controller may program initial modulation control attributes of the converter. The programming of the modulation control attributes may be based on characteristics or estimated characteristics of the converter. These characteristics may include any of an input voltage, a nominal output voltage, a nominal power, a switching frequency, a load, an inductance, an output capacitance, a voltage gain, and/or a transformer turn ratio of the converter. The modulation control attributes of the converter may include modulation control parameters such as duty cycles of different bridges or sections (hereinafter “bridges”) of the converter, a phase shift between different bridges, phase shifts between different complementary pairs of switches within a bridge, and/or a modulation control mode. The modulation control attributes may include pulse width modulation (PWM) attributes. In some embodiments, the modulation control attributes may include a threshold reactive current, which may be a minimum amount of reactive current in order to maintain soft switching such as ZVS. A modulation control mode may encompass or correspond to a specific phase shift technique.

The controller may adaptively and/or iteratively adjust the modulation control attributes depending on different operational condition information of the converter, such as a load level or power level, voltage gain, amount of excess reactive energy or excess reactive current, switching frequencies, and/or a temperature within the converter. The operational condition information may include or be obtained or derived from any or all of sensor data, changes in any characteristics, state information, status updates, imperfections, and/or deviations from initial characteristics, such as additional cables or wiring within the converter. The sensor data may include environmental related data such as temperature sensor data associated with the switches, humidity sensor data, and electronic sensor data such as voltage or current sensor data across one or more components or terminals of the converter. In some embodiments, the operational condition information may trigger an adjustment of one or more modulation control attributes. For example, the controller may iteratively adjust the threshold reactive current until a fluctuation of temperature is minimized, or falls to below a threshold level of fluctuation. In some embodiments, the controller may be configured to perform adjustment of the modulation control attributes for a converter having a unity voltage gain, in which a voltage ratio between a primary leg or primary bridge (hereinafter “bridge”) and a secondary bridge is one or approximately one. In other embodiments, additionally or alternatively, the controller may adjust the modulation control attributes for a converter having a non-unity voltage gain, such as in implementations involving energy storage.

In some embodiments, a modulation control mode may include or correspond to different phase shift techniques, including any or all of a single-phase shift (SPS), a double phase shift (DPS), a triple phase shift (TPS), an extended phase shift (EPS), and/or any other phase shift modes. The modulation control modes refer to shapes, profiles, or characteristics of waveforms (e.g. modulation waveforms) generated by the controller, which are used to modulate the converter. The waveforms may be implemented at outputs of the primary and secondary bridges as modulation signals to control ON and OFF states of the switches within the converter.

In some embodiments, the controller may implemental multimodal operation, in which the controller changes between different modulation control modes depending on operational condition information within the converter. The conditions may be indicative of a temperature, power level and/or amount of reactive current within the converter. The changing between different modulation control modes may include a change from a SPS mode to a TPS mode, and vice versa.

By iterative and adaptive controlling of the modulation control attributes of the converter, the controller maintains zero voltage switching (ZVS) within switches of the converter while maintaining an amount of power delivered by the converter. The controller maintains ZVS by maintaining a threshold level of reactive current that is used to sufficiently charge and/or discharge a voltage, current, and/or capacitance, such as an output capacitance across capacitors connected through the switches. The controller also minimizes excess reactive energy or excess reactive current within the converter. Therefore, the controller increases efficiency of the converter by maintaining ZVS to prevent or reduce switching losses and by reducing excess reactive energy or excess reactive current within the converter. The excess reactive energy or excess reactive current is not actively performing work and represents wasted energy.

As previously alluded to, the controller may control operations of the converter by generating one or more waveforms, such as modulation waveforms, according to the determined modulation control attributes of the converter. For example, upon determining duty cycles of different bridges, a phase shift between the bridges, and a modulation control mode, the controller may generate a primary waveform for a primary bridge, and a secondary waveform for a second bridge according to the determined duty cycles, phase shift, and modulation control mode. Alternatively, the controller may cause the waveforms to be generated. The waveforms may be implemented as full bridge output alternating current (AC) waveforms on both primary and secondary legs of the converter. The controller, or a different computing component or other component, may program one or more gate drivers in a manner consistent with the waveforms to control ON and OFF states of the switches.

Embodiments herein described confer a safe and efficient closed loop operation of a converter that is adjusted for different load levels and/or power levels of the converter without a lengthy procedure of power characterization, which increases robustness for different applications such as high voltage and high-power applications. The embodiments require no additional hardware and reduce requirements of a heat sink, thereby maintaining compactness of the electric system.

Embodiments of the invention implement an electric system which includes a converter configured to distribute electric energy from an energy source to a load, one or more interfaces coupled to the converter, and a controller system comprising the one or more interfaces and a controller. The controller system further comprises one or more hardware processors and memory storing computer instructions, the computer instructions when executed by the one or more hardware processors configured to perform steps. The steps include determining modulation control attributes of a converter based on characteristics of the converter. The characteristics may include a power level, an input voltage, output voltage, input capacitance, and/or output capacitance, and/or one or more characteristics of components within the converter such as switching frequencies of switches within the converter. The steps further include obtaining operational condition information corresponding to a component (e.g., electrical component) within the converter or corresponding to an output of the converter. The operational condition information may include sensor data, conditions, and/or updates in characteristics from the converter. For example, the operational condition information may include temperatures measured by sensors located within or near the switches, a power output of the converter, reactive currents within the converter, and/or voltages across switches of the converter. The steps further include iteratively controlling or adjusting the modulation control attributes based on the operational condition information. For example, the iteratively controlling or adjusting the modulation control attributes may include adjusting a threshold reactive current level (e.g., a minimum reactive current level) within the converter based on the temperature or changes in the temperature. The adjustment of the threshold reactive current level may, in turn, result in adjustment of the modulation control attributes. As another example, the iteratively controlling or adjusting the modulation control attributes may include adjusting a mode (e.g., SPS or TPS mode) of the converter based on an amount of reactive current within the converter. As another example, the iteratively controlling or adjusting the modulation control attributes may be based on a power outputted by the converter. The steps may further include implementing the iteratively adjusted modulation control attributes on the converter or controlling the converter based on the iteratively adjusted modulation control attributes.

In some embodiments, the converter comprises a DAB. In some embodiments, the DAB has an approximately unity voltage gain.

In some embodiments, the implementing of the iteratively adjusted modulation control attributes on the converter comprises generating one or more waveforms (e.g., modulation waveforms) according to the iteratively adjusted modulation control attributes and programming gate drivers that correspond to the switches of the converter according to the iteratively adjusted modulation control attributes.

In some embodiments, the converter comprises a primary bridge and a secondary bridge of the DAB. The modulation control attributes include any of a phase shift between an output voltage of the primary bridge and an output voltage of the secondary bridge, a duty cycle of the primary bridge, and a duty cycle of the secondary bridge.

In some embodiments, the generating of the one or more waveforms comprises generating a primary waveform corresponding to the primary bridge and a secondary waveform corresponding to the secondary bridge, the primary waveform at least partially overlapping with the secondary waveform.

In some embodiments, as alluded to previously, the iteratively controlling or adjusting the modulation control attributes includes adjusting a threshold reactive current level (e.g., a minimum reactive current level) within the converter based on the temperature, a profile of the temperature, or a change in the temperature.

In some embodiments, the iteratively controlling or adjusting the modulation control attributes further includes adjusting a modulation control mode of the converter based on a comparison between the amount of reactive current within the converter and the threshold reactive current level.

In some embodiments, in response to the amount of reactive current within the converter failing to satisfy the threshold reactive current level, the iteratively controlling or adjusting the operation includes changing the modulation control mode from SPS to TPS. Additionally or alternatively, in response to the amount of reactive current within the converter failing to satisfy the threshold reactive current level, the iteratively controlling or adjusting the modulation control attributes includes changing one or more of the modulation control modes.

In some embodiments, the iteratively controlling or adjusting the modulation control attributes further includes adjusting the modulation control attributes based on voltages measured across one or more of the switches of the converter.

In some embodiments, the iteratively controlling or adjusting the modulation control attributes further includes adjusting a modulation control mode based on a power level of the converter.

Embodiments of the invention implement a method by a controller system within an electric system, the electric system comprising a converter configured to distribute electric energy from an energy source to a load. The controller system includes one or more interfaces coupled to the converter. The controller system includes one or more hardware processors and memory storing computer instructions, the computer instructions when executed by the one or more hardware processors configured to perform operations. The method comprises determining modulation control attributes of a converter based on characteristics of the converter. The characteristics may include a power level, an input voltage, output voltage, input capacitance, and/or output capacitance. and/or one or more characteristics of components within the converter such as switching frequencies of switches within the converter. The method further comprises obtaining operational condition information, including operational information such as sensor data, state information, and/or updates in characteristics from the converter. For example, the operational condition information may include temperatures measured by sensors located within or near the switches, a power output of the converter, reactive currents within the converter, and/or voltages across switches of the converter. The method further comprises iteratively controlling or adjusting the modulation control attributes based on the operational condition information. For example, the iteratively controlling or adjusting the modulation control attributes may include adjusting a threshold reactive current level (e.g., a minimum reactive current level) within the converter based on environmental data such as the temperature or changes in the temperature. The adjustment of the threshold reactive current level may cause changes in the modulation control attributes. As another example, the iteratively controlling or adjusting the modulation control attributes may include adjusting a modulation control mode (e.g., SPS or TPS mode) of the converter based on an amount of reactive current within the converter. As another example, the iterative controlling or adjusting the modulation control attributes may be based on a power outputted by the converter. The method further comprises implementing the iteratively adjusted modulation control attributes on the converter or controlling the converter based on the iteratively adjusted modulation control attributes.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1A is a diagram of an example electric system and associated components including a converter, illustrating a mechanism of modulation of the converter to reduce losses such as switching losses and reactive power losses, according to some embodiments of the present invention.

FIG. 1B is a diagram of an example electric system, including a converter, illustrating the iterative adjustment of modulation control attributes of the converter based on feedback of operational condition information within the converter, according to some embodiments of the present invention.

FIG. 1C is a diagram illustrating example implementations of control of different modulation waveform types, according to some embodiments of the present invention.

FIG. 1D is a diagram illustrating example implementations of control of different modulation waveform characteristics, according to some embodiments of the present invention.

FIG. 2A is a diagram of an example electric system, including a converter, illustrating the iterative adjustment of modulation control attributes of the converter to reduce losses such as switching losses and reactive power losses, according to some embodiments of the present invention.

FIG. 2B is a diagram illustrating an example effect of modulation on switching cycles of transistors, consistent with FIGS. 1A-1D and FIG. 2A, according to some embodiments of the present invention.

FIG. 3 is a diagram illustrating example logic of a microcontroller to control a modulation mechanism at gate drivers of a converter, according to some embodiments of the present invention.

FIG. 4 is an example diagram including logic blocks to implement modulation control attributes, consistent with FIGS. 1A, 1B, 1C, 1D, 2A, 2B and 3, according to some embodiments of the present invention.

FIG. 5 is a block diagram of an example controller which controls operations of the converter shown and described in FIGS. 1A-1D, 2A-2B, 3, and 4, according to some embodiments of the present invention.

FIG. 6 is a block diagram of an example modulation control attribute controlling engine within the controller shown and described in FIGS. 1A-1D, 2A-2B, 3, and 4, according to some embodiments of the present invention.

FIG. 7 is a block diagram of an example modulation control parameter controlling engine within the controller shown and described in FIGS. 1A-1D, 2A-2B, 3, and 4, according to some embodiments of the present invention.

FIG. 8 is a block diagram of an example modulation control mode controlling engine within the controller shown and described in FIGS. 1A-1D, 2A-2B, 3, and 4, according to some embodiments of the present invention.

FIG. 9 is a flowchart of a method of controlling an operation of a converter, as implemented within an electric system, according to some embodiments of the present invention.

FIG. 10 is a block diagram of a computing system, according to some embodiments of the present invention.

FIG. 11 is a diagram illustrating theoretical regions in which zero-voltage switching (ZVS) is attained for a converter.

FIGS. 12-32 illustrate diagrams showing testing results of different modulation control attributes of the converters.

### DETAILED DESCRIPTION

A claimed solution rooted in computer technology overcomes problems specifically arising in the realm of computer technology, in particular, to control of an electric system for energy distribution. The electric system includes converter circuitry (e.g., of a DAB) that transforms and distributes energy from one or more energy storage components to one or more loads that draw energy from the energy storage components. The electric system also includes a controller that maintains and controls operations of the electric system to facilitate distribution of energy to and from the energy storage components in a bidirectional manner. The controller described herein improves efficiency of operation of the converter by eliminating or reducing losses, including switching losses and reactive power losses caused by excess reactive current. The controller adjusts an operation control attribute of the converter under different operational conditions, such as temperatures, reactive current levels, load levels, power levels, switching frequencies, and/or different voltage gains.

The energy storage components may include different types of electronic components, such as, for example, one or more batteries, supercapacitors, renewable energy sources such as photovoltaics, chargers, generators, motors, substations, and/or other energy sources. The converter circuitry may include one or more solid state transformers (SSTs).

The controller may maintain, control, and/or adjust operation control attributes of the converter in a closed loop manner in order to reduce or minimize switching losses at switches of the converter, and to reduce or minimize excess reactive current or reactive energy within the converter. A threshold level of reactive current or reactive energy is required to facilitate soft switching (e.g., ZVS). For example, the reactive current dissipates capacitance across capacitors of the switches. However, an excess amount of reactive current or reactive energy is wasteful because reactive energy performs no active work. Therefore, the controller aims to balance between maintaining a threshold reactive current level that is sufficient to facilitate ZVS, while minimizing excess reactive current.

The controller may control and/or determine modulation control attributes of the converter. The modulation control attributes may encompass duty cycles of different bridges of the converter, a phase shift between different bridges, a phase shift between complementary pairs of switches in a primary bridge, a phase shift between complementary pairs of switches in a secondary bridge, and/or modulation control modes which correspond to phase shift techniques. First, the controller may program the converter according to initial modulation control attributes. The programming of the modulation control attributes may be based on characteristics or estimated characteristics of the converter. These characteristics may include any of an input voltage, a nominal output voltage, a nominal power, a switching frequency, a load, an inductance, an output capacitance, a voltage gain, and/or a transformer turn ratio of the converter. The controller may adaptively and/or iteratively adjust the modulation control attributes depending on operational condition information of the converter, such as a load or power level, voltage gain, amount of excess reactive energy or excess reactive current, switching frequencies, other input and/or output conditions of the converter, and/or a temperature within the converter. The operational condition information may be obtained or derived from sensor data (e.g., environmental sensor data such as temperatures associated with the switches), characteristics or changes in any characteristics associated with the converter, and/or deviations from the initial characteristics or initial estimated characteristics. In some embodiments, the controller may adjust the modulation control attributes for a converter having a unity voltage gain, or for a non-unity voltage gain.

In some embodiments, the controller may adjust a threshold reactive current level depending on the temperature measured within the converter, and/or in response to a change in the temperature within the converter. The threshold reactive current level may indicate a minimum required reactive current within the converter in order to maintain ZVS. In some embodiments, the controller may iteratively adjust the threshold reactive current level until temperature fluctuations within the converter decrease to below a threshold fluctuation level. The temperature fluctuations within the converter may be measured at the switches of the converter. In some embodiments, the controller may counteract an increase in temperature by changing the threshold reactive current. This change in the threshold reactive current may encompass a decrease of the threshold reactive current.

The controller may adjust one or more of the modulation control attributes based on the temperature and/or the changed threshold reactive current. For example, the controller may react to an increase in temperature and/or a decrease of the threshold reactive current by reducing a primary duty cycle and/or a secondary duty cycle corresponding to the primary bridge and/or the secondary bridge, respectively. Additionally or alternatively, the controller may adjust a phase shift between the primary and secondary bridges. The amount of reduction of the primary duty cycle or the secondary duty cycle may be limited in order to maintain a sufficient amount of power delivered by the converter.

In some embodiments, the controller may adjust one or more of the modulation control attributes depending on the amount of reactive current, or excess reactive current, within the converter. If the controller determines that excess reactive current is flowing through the converter, or that an amount of the excess reactive current exceeds a threshold amount, the controller may adjust one or more of the modulation control attributes in an attempt to reduce the excess reactive current. For example, the controller may reduce the primary duty cycle and/or the secondary duty cycle. In some embodiments, if the controller determines that an amount of reactive current has fallen below the threshold reactive current, and/or otherwise determines that ZVS is not satisfied within the converter, the controller may adjust one or more of the modulation control attributes to increase the amount of reactive current. The controller may determine that ZVS fails to be satisfied as a result of measuring a nonzero voltage and a nonzero current, or a voltage and current that are above threshold levels, across any of the switches during switching. In such a scenario, the controller may increase the primary duty cycle and/or the secondary duty cycle, and/or adjust a phase shift between the primary bridge and the secondary bridge. Additionally or alternatively, if the converter is operating in a SPS modulation control mode, the converter may change the modulation control mode to a TPS modulation control mode to restore ZVS.

In some embodiments, the controller may adjust one or more of the modulation control attributes depending on the power outputted by the converter. If the controller determines that the output power is decreasing and/or has fallen below a threshold power level, the controller may adjust one or more of the modulation control attributes in order to increase the power delivered. For example, the controller may increase the primary duty cycle and/or the secondary duty cycle, and/or adjust a phase shift between the primary bridge and the secondary bridge, to increase the power delivered by the converter.

In some embodiments, modulation control modes that correspond to different phase shift techniques may include any or all of a SPS, a DPS, a TPS, an extended phase shift (EPS), and/or any other phase shift modes. The modulation control modes refer to shapes, profiles, or characteristics of modulated waveforms generated by the controller. In a SPS modulation control mode, square wave voltages have same duty cycles for both primary and secondary bridges. A TPS modulation control mode may include two additional degrees of freedom. These two additional degrees of freedom correspond to phase shifts of complementary pairs of switches on both the primary and secondary bridges. In a TPS modulation control mode, duty cycles of the primary bridges and the secondary bridges may be different.

In some embodiments, the controller may implemental multimodal operation, in which the controller changes, or causes changes, between different modulation control modes depending on operational condition information or within the converter. The changing between modulation control modes may encompass a change from a SPS mode to a TPS mode, or vice versa. The operational condition information may include a temperature, power or load level, voltage within any components of the converter, and/or an amount of reactive current within the converter. By iterative and adaptive controlling of the modulation control attributes of the converter, the controller maintains zero voltage switching (ZVS) within switches of the converter while maintaining an amount of power delivered by the converter. The controller maintains ZVS by maintaining a threshold level of reactive current that is used to sufficiently charge and/or discharge a voltage, current, and/or capacitance within the converter. The reactive current may discharge an output capacitance across capacitors connected through the switches. The controller also minimizes excess reactive energy or excess reactive current within the converter, because the excess reactive power performs no active work. Therefore, the controller increases efficiency of the converter by maintaining ZVS to prevent or reduce switching losses while reducing losses otherwise caused by excess reactive energy or excess reactive current within the converter.

In some embodiments, the controller may adjust one or more of the modulation control modes depending on a power level of the converter. For example, if a power level of the converter is above a first threshold power, the controller may set a modulation control mode of the converter to a SPS modulation control mode. A SPS modulation control mode may provide better performance at high power levels due to lower root mean square (RMS) and peak currents. However, at low power levels, a SPS modulation control mode may not provide ZVS due to the threshold reactive current not being satisfied. Thus, if the power level of the converter is at or below the first threshold power, the controller may set a TPS modulation control mode for the converter.

In other embodiments, if a power level of the converter is between the first threshold power and a second threshold power, the controller may set a modulation control mode of the converter to a SPS modulation control mode. If the power level of the converter is below the first threshold power or above the second threshold power, the controller may set the modulation control mode to a TPS modulation control mode. In some embodiments, the first threshold power may be between 4 kilowatts (kW) and 5 kW. In some embodiments, the second threshold power may be between 6 kW and 12 kW. Using the SPS modulation control mode may result in loss of ZVS at around a power level of 5 kW. The loss of ZVS may occur on the primary bridge and/or on the secondary bridge.

In some embodiments, upon determining and/or adjusting the modulation control attributes, the controller generates, or causes to be generated, modulation waveforms that have the modulation control attributes. The modulation waveforms may include properties of the determined duty cycles and phase shifts between the modulation waveforms. The modulation waveforms may be implemented as full bridge output AC waveforms on both the primary and secondary bridges, and are used to determine ON and OFF states of complementary pairs of switches. The modulation waveforms may correspond to and indicate switching sequences of the converter. The controller may generate a primary modulation waveform corresponding to the primary bridge, which has the determined duty cycle of the primary bridge. The controller may also generate a secondary modulation waveform corresponding to the secondary bridge, which has the determined duty cycle of the secondary bridge. The controller may set a phase shift between the primary modulation waveform and the secondary modulation waveform to be consistent with the determined phase shift. Furthermore, the controller may generate the primary modulation waveform and/or the secondary modulation waveform according to SPS or TPS. The foregoing figures elucidate these concepts.

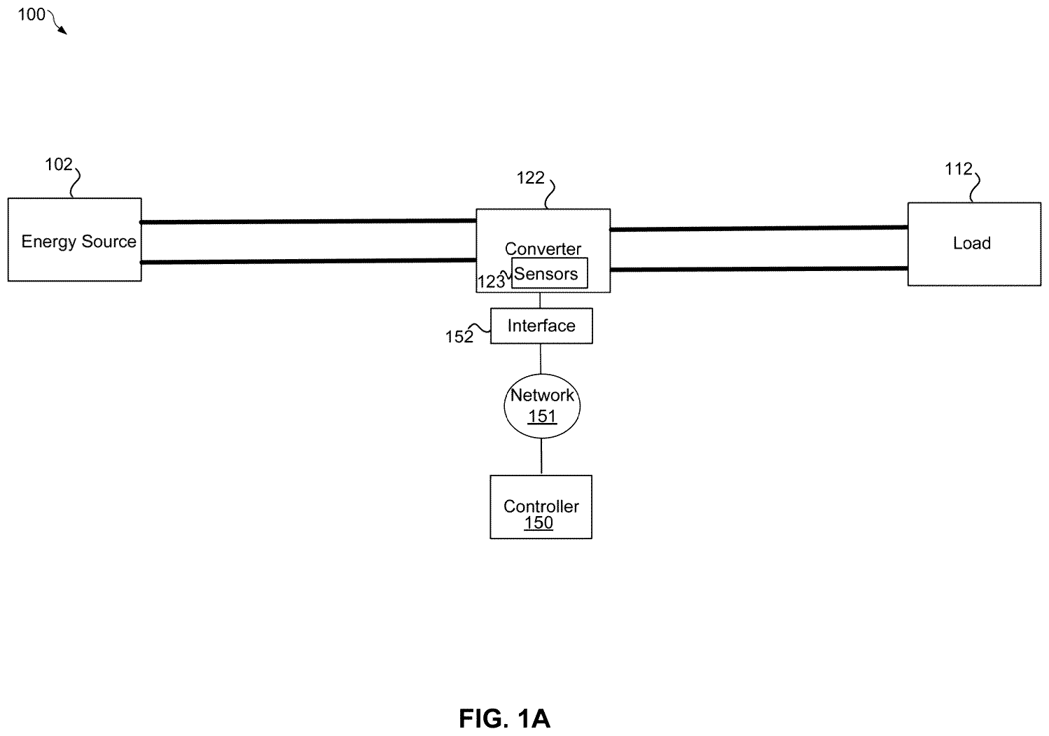

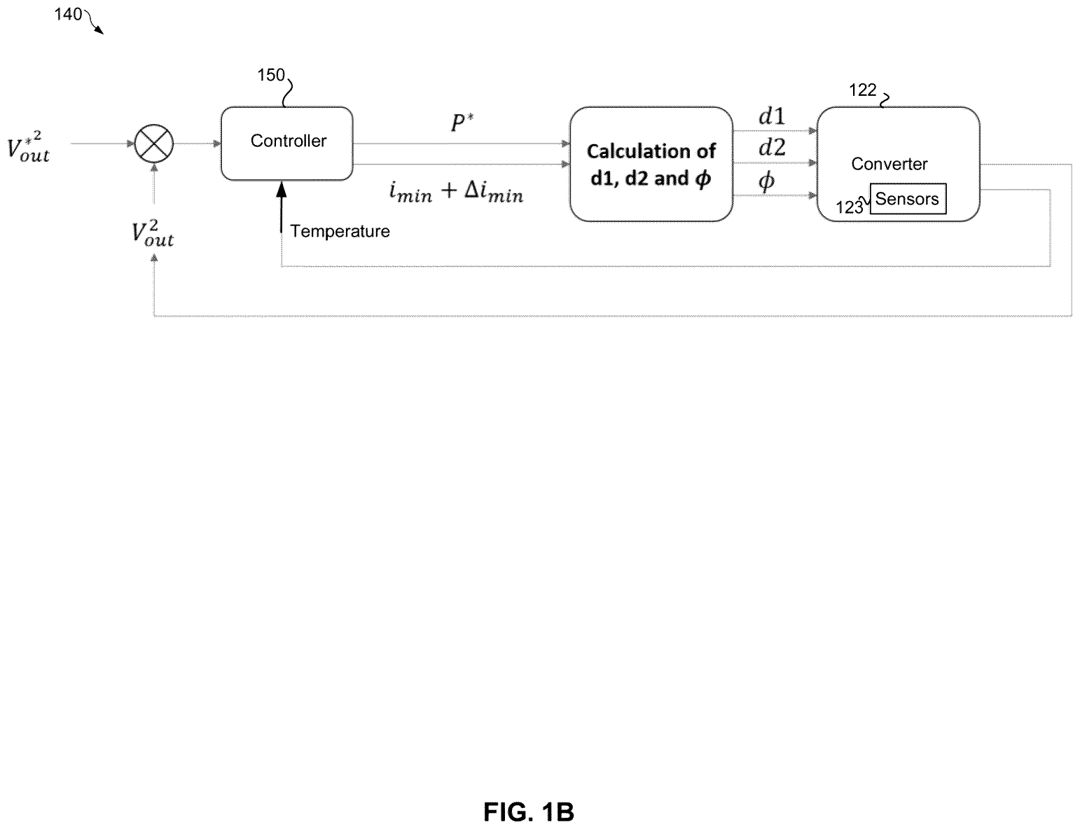

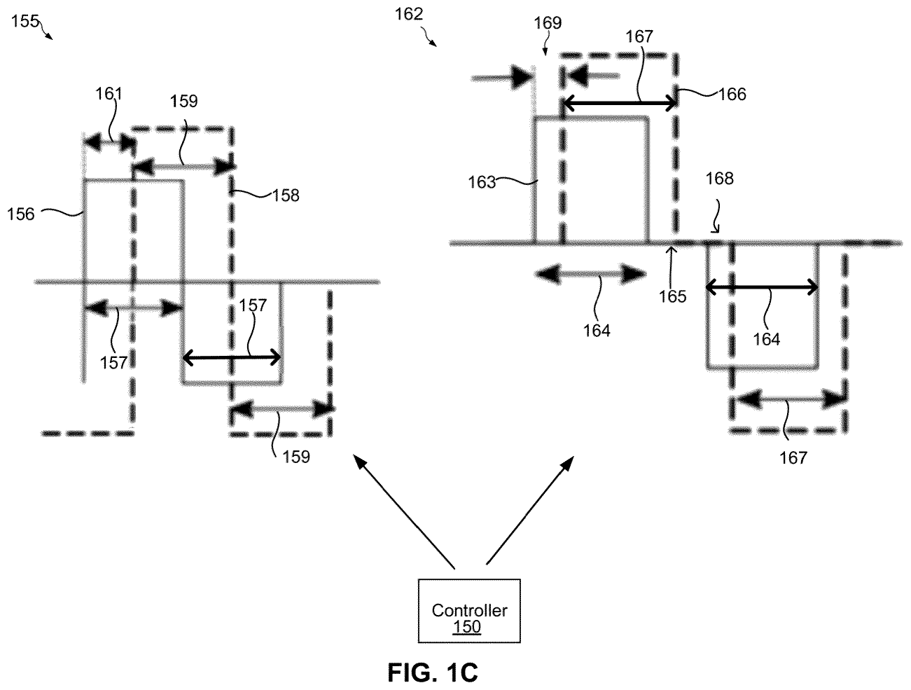

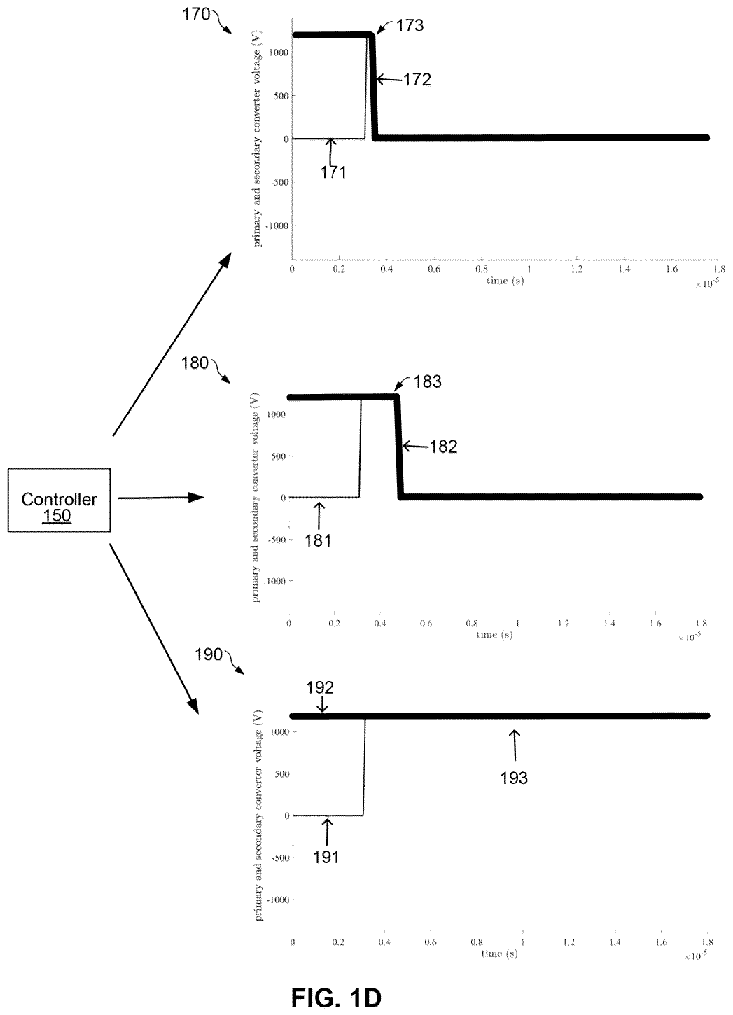

FIG. 1A depicts a diagram of an example electric system 100 and associated components including a converter 122 and a controller 150. An energy source 102 may supply input power to the converter 122. In some embodiments, the converter 122 may include a DAB. The converter 122 may operate with any voltage gain, such as a unity voltage gain. The converter 122 may deliver output power to a load 112. Within the converter 122 may be one or more sensors 123 that measure sensor data within the converter 122. For example, readings from the one or more sensors 123 may be indicative of one or more operational conditions within the converter 122, such as a load level (e.g., a current load level) or power level, voltage gain, amount of excess reactive energy or excess reactive current, switching frequencies, and/or a temperature or other environmental condition, such as humidity, within the converter 122. The one or more sensors 123 may include temperature sensors at one or more switches of the converter 122. The one or more sensors 123 may additionally or alternatively include electric parameter sensors such as current sensors and/or voltage sensors. The current sensors may determine one or more currents within the converter 122, such as reactive currents and/or currents across one or more electronic components on including inductors and/or capacitors or across one or more terminals. The voltage sensors may determine one or more voltages such as an input voltage and/or an output voltage at the primary bridge and secondary bridge. The one or more sensors 123 may further include other electric parameter sensors, such as sensors that detect a load level.

The controller 150 may include software, hardware, and/or firmware to control operations of the converter 122. In some embodiments, the controller 150 may include one or more processors that read and/or write instructions (e.g., which may include parameters, expressions, protocols, evaluations, conditions, arguments, and/or functions) to implement the control of the operations. These operations may include receiving communications from the converter 122 and/or from the sensors 123, and transmitting communications to the converter 122, via an interface 152. The communications may be transmitted over a network 151.

The controller 150 may program initial modulation control attributes of the converter 122 based on characteristics of the converter 122. For example, the characteristics of the converter 122 may include any of an input voltage, a nominal output voltage, a nominal power, a switching frequency, a load, an inductance, an output capacitance, a voltage again, and/or a transformer turn ratio. In some embodiments, the modulation control attributes further include the threshold reactive current, which is a minimum amount of reactive current required for ZVS. In some embodiments, the threshold reactive current may be obtained based on a capacitance (e.g., an output capacitance), a voltage (e.g., an output voltage), and an external inductance of an inductor, which shapes transformer current based on full bridge output waveforms on both primary and secondary bridges of the converter 122. The full bridge output waveforms may be implemented as, or based on, the waveforms generated by the controller 150 using the modulation control attributes. Although the discussion focuses on modulation control attributes, it is contemplated that the controller 150 may, additionally or alternatively, program other attributes such as non-modulation related attributes.

In some embodiments, the threshold reactive current iₘᵢₙ may be obtained from, or based on,

$${i}_{min} = \sqrt{\frac{2 {CV}^{2}}{{L}_{ext}}} .$$

Here, C may include the capacitance, V may include the voltage, and Lₑₓₜ may include the external inductance of the inductor, which may include a sum of transformer leakage inductance and any additional inductance.

$${i}_{min} = \sqrt{\frac{2 {CV}^{2}}{{L}_{ext}}}$$

The controller 150 may selectively adjust one or more modulation control attributes of the converter 122 in response to receiving an indication of an operational condition within the converter 122. The operational condition may include or be obtained or derived from any or all of sensor data, changes in any characteristics, state information, status updates, imperfections, and/or deviations from initial characteristics within the converter 122. The modulation control attributes may include any modulation control parameters such as duty cycles of the primary bridge and the secondary bridge, a phase shift between the primary bridge and the secondary bridge, a phase shift between complementary pairs of switches on the primary bridge, and/or a phase shift between complementary pairs of switches on the secondary bridge. The modulation control attributes may include one or more modulation control modes which correspond to phase shift techniques, such as SPS and TPS.

In some embodiments, the interface 152 may include one or more interfaces that convert commands from the controller 150 into signals. For example, the controller 150 may transmit commands regarding the modulation control attributes including the modulation control parameters and/or one or more modulation control modes. The interface 152 may translate these commands into specific actions to generate modulation waveforms including pulses correspond to the modulation control attributes, to be applied at outputs of the primary and secondary bridges. In some embodiments, additionally or alternatively, the interface 152 may communicate sensor signals such as environmental data (e.g., temperature and/or humidity values) and/or any state information or status updates, such as status of obtained sensor data, and/or an operational status of the converter 122. In some embodiments, the interface 152 may be configured via control signals and/or user interfaces as needed. In some embodiments, the controller 150 may communicate with a single interface or any number of interfaces. In some embodiments, the controller 150 and any or all of the interfaces that the controller 150 communicates with may be combined together to form a controller system.

The network 151 may include any secured communication network such as an encrypted network. The network 151 may represent one or more computer networks (e.g., LAN, WAN, or the like) or other transmission mediums. The network 151 may provide communication within the electric system 100 and/or between the electric system 100 and other external systems or infrastructures. In some embodiments, the network 151 includes one or more computing devices, routers, cables, buses, and/or other network topologies (e.g., mesh, and the like). In some embodiments, the network 151 may be wired and/or wireless. In various embodiments, the network 151 may include the Internet, one or more wide area networks (WANs) or local area networks (LANs), one or more networks that may be public, private, IP-based, non-IP based, and so forth.

FIG. 1B depicts a diagram of an example implementation 140 of the controller 150 configured to iteratively adjust modulation control attributes of the converter 122 based on feedback from the converter 122 and/or from the sensor 123. The controller 150 may set initial modulation control attributes, including a duty cycle of a primary bridge of the converter 122, denoted as d₁, a duty cycle of a secondary bridge of the converter 122, denoted as d₂, and a phase shift between the primary bridge and the secondary bridge, denoted as p. In some embodiments, additionally or alternatively, other initial modulation control attributes may include a phase shift between complementary pairs of switches within the primary bridge, a phase shift between complementary pairs of switches within the secondary bridge, and/or the threshold reactive current.

The feedback may include or indicate any operational condition. For example, the feedback may indicate an environmental condition, such as temperature measured within the switches of the converter 122. The controller 150 may, in response to obtaining the feedback regarding the temperature, iteratively adjust the threshold reactive current. For example, if the controller 150 detects that the temperature is above a threshold temperature, then the controller 150 may decrease the threshold reactive current. Furthermore, the controller 150 may obtain a power level of the converter 122 from a square of the output voltage of the converter 122. The controller 150 may selectively update modulation control attributes based on the iteratively adjusted threshold reactive current and/or the power outputted by the converter 122. For example, the controller 150 may optimize or otherwise adjust the modulation control attributes in order to satisfy constraints that both a threshold reactive current and a minimum power output are to be maintained, while minimizing an amount of excess reactive current. That is, the controller 150 may continuously and/or iteratively program the modulation control attributes such that at least the threshold reactive current flows through the converter 122 and the converter delivers at least the minimum power output. The programming of the modulation control attributes may entail adjusting d₁, d₂, and φ, as well as determining a modulation control mode. The controller 150 may generate waveforms, or otherwise may cause the generation of the waveforms (e.g., by the interface 152) according to the determined modulation control mode. In some embodiments, the determining of the modulation control mode may include selecting a modulation control mode from SPS and TPS modulation control modes. In some embodiments, the determining of the modulation control mode may include alternating between the SPS and TPS modulation control modes.

FIG. 1C is a diagram illustrating an example of the controller 150 programming modulation control attributes, in particular, SPS and TPS modulation control modes. An example SPS modulation control mode or SPS technique (hereinafter “SPS modulation control mode”) 155 and an example TPS modulation control mode or TPS technique 162 are illustrated. The SPS modulation control mode 155 includes primary and secondary waveforms that have a same duty cycle and that are phase shifted. The SPS modulation control mode 155 includes a primary waveform 156 having an ON period 157, and a secondary waveform 158 having an ON period 159, and a phase shift 161 between the primary waveform 156 and the secondary waveform 158. The ON periods 157 and 159 may contain positive voltage cycles and negative voltage cycles. The TPS modulation control mode 162 includes primary and secondary waveforms that may have different duty cycles and that are phase shifted. In addition, complementary pairs of switches within each of the primary and secondary bridges may be phase shifted, as manifested by zero-voltage periods within the primary and secondary waveforms. The TPS modulation control mode 162 includes a primary waveform 163 having an ON period 164, and a zero-voltage period 165, along with a secondary waveform 166 having an ON period 167, and a zero-voltage period 168. The ON periods 164 and 167 may contain positive voltage cycles and negative voltage cycles. The primary waveform 163 and the secondary waveform 166 may have a phase shift 169.

FIG. 1D is a diagram illustrating an example of the controller 150 programming modulation control attributes. In FIG. 1D, following the iterative adjustment of the modulation control attributes, the controller 150 may generate waveforms, or cause the generation of waveforms using the interface 152, according to an overlapping mode of primary and secondary waveforms. The overlapping mode may encompass overlapping portions of the primary waveform and secondary waveform in which voltages during at least a portion of ON periods of both the primary waveform and secondary waveform are overlapping. As illustrated in FIG. 1D, the controller 150 may generate example waveforms 170, 180, and/or 190 according to the overlapping mode. The waveforms 170, 180, and 190 may correspond to different duty cycles and/or different power levels. For example, at higher power levels, an extent of overlap of the waveforms may be greater. The waveform 170 may include a primary waveform 171 and a secondary waveform 172, with an overlapping portion 173 which coincides with ON periods for both the primary waveform 171 and the secondary waveform 172. The waveform 180 may include a primary waveform 181 and a secondary waveform 182, with an overlapping portion 183 which coincides with ON periods for both the primary waveform 181 and the secondary waveform 182. The waveform 190 may include a primary waveform 191 and a secondary waveform 192, with an overlapping portion 193 in which the primary waveform 191 and the secondary waveform 192 are both in ON states.

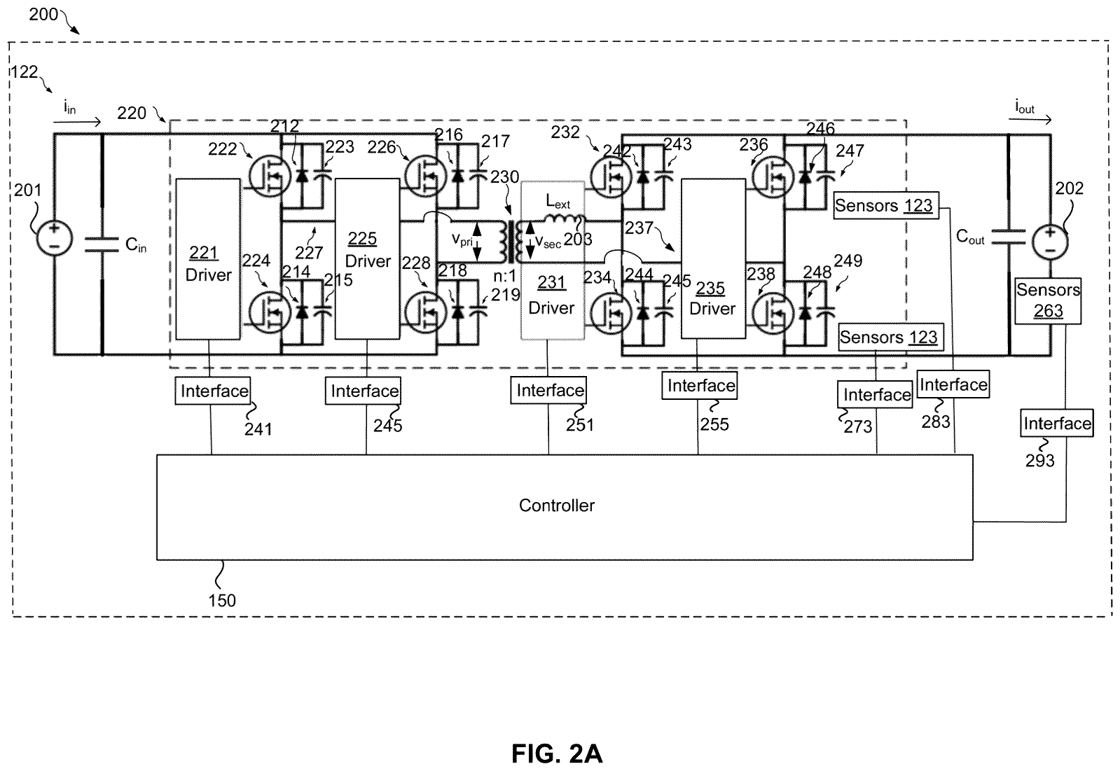

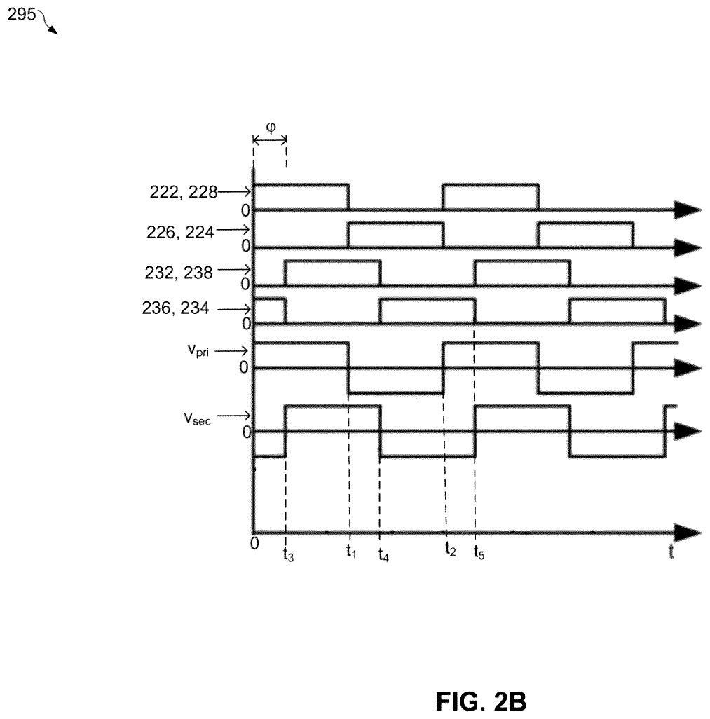

FIG. 2A depicts a diagram of a system 200, containing the converter 122 and the controller 150 that controls operations of the converter 122 in order to reduce or minimize losses such as switching losses and power losses originating from excess reactive current. Any principles described in FIGS. 1A, 1B, 1C, and/or 1D may also be applicable to FIG. 2A, and vice versa. The converter 122 includes a converter circuit 220, which may include transistors 222, 224, 226, 228, 232, 234, 236, and 238 operating in a soft switching mode (e.g., ZVS), and may include a transformer (e.g., a high frequency transformer) 230. A transformer may have a n:1 transformer ratio. Power may be exchanged from the primary bridge to the secondary bridge, or vice versa, via an external inductor 203 having inductance Lₑₓₜ. The external inductor 203 may shape transformer current based on outputted waveforms (e.g., alternating current waveforms) outputted on both primary and secondary bridges. These outputted waveforms may be implemented based on the modulation control attributes, including duty cycles and phase shifts. For example, the outputted waveforms may have the same duty cycles as the determined duty cycles and the same phase shifts as the determined phase shifts.

In FIG. 2A, the converter 122 may include a dual-active bridge (DAB). In the converter circuit 220, complementary switch pairs comprise four pairs including transistors 222 and 224, 226 and 228, 232 and 234 and 236 and 238. The converter circuit 220 may include additional circuit components such as diodes and/or capacitors to reduce reverse conduction losses and limit voltage slew rate respectively. The diodes illustrated may represent internal parasitic diodes of the transistors 222, 224, 226, 228, 232, 234, 236, and 238 and/or additional external diodes. The capacitors illustrated may represent internal capacitances of the transistors 222, 224, 226, 228, 232, 234, 236, and 238 and/or additional capacitances. Furthermore, capacitances across the capacitors are to be discharged sufficiently prior to turning on of the transistors 222, 224, 226, 228, 232, 234, 236, and 238. In particular, the converter circuit 220 may include a diode 212 and a capacitor 213 in parallel with the transistor 222, a diode 214 and a capacitor 215 in parallel with the transistor 224, a diode 216 and a capacitor 217 in parallel with the transistor 226, a diode 218 and a capacitor 219 in parallel with the transistor 228, a diode 242 and a capacitor 243 in parallel with the transistor 232, a diode 244 and a capacitor 245 in parallel with the transistor 234, a diode 246 and a capacitor 247 in parallel with the transistor 236, and a diode 248 and a capacitor 249 in parallel with the transistor 238. An energy source 201 and an input capacitor having capacitance Cᵢₙ may be coupled to the converter circuit 220 to supply power to the converter circuit 220. An output load 202 and an output capacitor having capacitance Cₒᵤₜ within the system 200 may be coupled to the output of converter circuit 220.

One or more drivers 221, 225, 231 and 235 control switching of the transistors 222, 224, 226, 228, 232, 234, 236, and 238 ON and OFF by sending a control (e.g., voltage) signal to the gate of each transistors 222, 224, 226, 228, 232, 234, 236, and 238. The controller 150 may control the drivers 221, 225, 231 and 235 by programming modulation control attributes of the converter 122, and generating waveforms or causing generation of the waveforms using the interface 152 according to the modulation control attributes. In some embodiments, the waveforms may include pulse width modulation (PWM) pulses. The controller may program the drivers consistent with the waveforms and/or the modulation control attributes. If a control signal to the gate has an amplitude that exceeds a threshold voltage (e.g., a gate voltage), then the waveform causes the transistor to turn ON. Otherwise, if a driver does not transmit the waveform or if the waveform has an amplitude or voltage lower than the threshold voltage, then the transistor will remain OFF. In other examples, the drivers 221, 225, 231 and 235 may operate in a different manner.

As shown in FIG. 2A, the driver 221 may control the transistors 222 and 224. The driver 225 may control the transistors 226 and 228. The driver 231 may control the transistors 232 and 234. The driver 235 may control the transistors 236 and 238. Although FIG. 2 illustrates one driver controlling two transistors, a driver may control a different number of transistors or control different transistors at different times. For example, a driver may, at one point in time, send a signal to a first transistor to switch the first transistor to an ON state while refraining from sending a signal to a second transistor to maintain the second transistor in an OFF state. In other alternative embodiments, one driver may control switching OFF and ON of a single transistor, or any number of transistors (e.g., four transistors or eight transistors).

Within the converter circuit 220, a first current flow path may be defined between the transistor 222, a path 227 and transistor 228. The transistors 222 and 228 may be both in an ON state or in an OFF state, as regulated by the drivers 221 and 225. A second current flow path may be defined between the transistor 226, the path 227, and the transistor 224. Thus, the transistors 226 and 224 may be both in an ON state or in an OFF state, as regulated by the drivers 225 and 221. A third current flow path may be defined between the transistor 232, a path 237, and the transistor 238. Thus, the transistors 232 and 238 may be both in an ON state or in an OFF state, as regulated by the drivers 231 and 235. A fourth current flow path may be defined between the transistor 236, the path 237, and the transistor 234. Thus, the transistors 232 and 238 may be both in an ON state or in an OFF state, as regulated by the drivers 231 and 235. Current flow from a primary bridge (e.g., the components on the left side of the transformer 230), such as current flowing through the transistors 226 and 228, may be transmitted via induction, via the external inductor 203, to a secondary bridge on the other side of the transformer 230. Meanwhile, current flow from the secondary bridge, such as current flowing through the transistors 232 and 234, may be transmitted via induction to the primary bridge. In such a manner, the converter circuit 220 facilitates bidirectional transfer of energy. In other embodiments with different configurations, and more than two current flow paths within a single bridge, at most one current flow path is permitted to be active at a given point in time.

In FIG. 2A, an entire cycle within the primary bridge may include the following operation cycles:
1. a first operation cycle, in which the transistors 222 and 228 are in an ON state while the transistors 226 and 224 are in an OFF state,
2. a first dead time in which the transistors 226, 224, 222, and 228 are all in an OFF state,
3. a second operation cycle in which the transistors 226 and 224 are in an ON state while the transistors 222 and 228 are in an OFF state,
4. a second dead time in which the transistors 226, 224, 222, and 228 are all in an OFF state,
5. followed by the first operation cycle.

Similarly, an entire cycle within the secondary bridge may include the following operation cycles:
1. a third operation cycle in which the transistors 232 and 238 are in an ON state while the transistors 236 and 234 are in an OFF state,
2. a third dead time in which the transistors 236, 234, 232, and 238 are all in an OFF state,
3. a fourth operation cycle in which the transistors 236 and 234 are in an ON state while the transistors 232 and 238 are in an OFF state,
4. a fourth dead time in which the transistors 236, 234, 232, and 238 are all in an OFF state,
5. followed by the third operation cycle.

The controller 150 may program the converter 122 according to modulation control attributes, consistent with the previously described operation cycles. The modulation control attributes may include any of a duty ratio of the primary bridge, a duty ratio of the secondary bridge, a phase shift between the primary bridge and the secondary bridge, a phase shift between complementary pairs of transistors on the primary bridge, and a phase shift between complementary pairs of transistors on the secondary bridge. In some embodiments, the modulation control attributes may include a threshold reactive current, which is a minimum amount of reactive current to maintain ZVS. The controller may iteratively adjust the threshold reactive current based on the temperature. In some embodiments, the controller may iteratively adjust the threshold reactive current until a fluctuation in temperature decreases to below a threshold level of fluctuation. The phase shift between complementary pairs of transistors on the primary bridge may be between a first pair including the transistors 222 and 228 and a second pair including the transistors 224 and 226. The phase shift between complementary pairs of transistors on the secondary bridge may be between a third pair including the transistors 232 and 238 and a fourth pair including the transistors 234 and 236. The controller 150 may initially program the converter 122 according to characteristics of the converter 122. These characteristics may include any of an input voltage, a nominal output voltage, a nominal power, a switching frequency, a load, an inductance, an output capacitance, a voltage gain, and/or a transformer turn ratio of the converter 122. The controller 150 may set the modulation control attributes in order to maintain ZVS and maintain a minimum power output of the converter 122.

Furthermore, the controller 150 may receive feedback regarding one or more operational conditions within the converter 122, via communication with the one or more sensors and/or interfaces, including the one or more sensors 123, one or more sensors 263, and/or interfaces 273, 283, and/or 293. The sensors 123 may measure environmental related information such as temperatures within each of the transistors 236, and/or 238. Sensor data from the sensors 123 may be transmitted via the interfaces 273 and 283 to the controller 150. Although not shown for simplicity, the same sensors 123, or different sensors, may be connected to and measure environmental related information within each of the other transistors 222, 224, 226, 228, 232, and/or 234, and additional interfaces may facilitate communication between any additional sensors and the controller 150. The one or more sensors 263 may be connected to and measure electricity information at an output of the converter 122. For example, the one or more sensors 263 may measure an output voltage and/or an output power of the converter 122. Sensor data from the sensors 263 may be transmitted via the interface 293 to the controller 150. In some embodiments, the interfaces 273, 283, and/or 293 may be implemented in a same or similar manner as the interface 152 of FIG. 1A. Additional interfaces may connect between the controller 150 and different components or terminals within the converter 122 in order to transmit any operational condition information within the converter 122 to the controller 150.

The operational condition information within the converter 122 may include or be obtained or derived from any or all of the aforementioned sensor data, changes in any characteristics, state information, status updates, imperfections, and/or deviations from initial characteristics within the converter 122. The sensor data may include environmental related data such as temperature sensor data associated with the switches, humidity sensor data, and electronic sensor data such as voltage or current sensor data across one or more components or terminals of the converter. The controller 150 may adaptively and/or iteratively adjust the modulation control attributes depending on different operational conditions of the converter, such as a load level, power level, voltage gain, amount of excess reactive energy or excess reactive current, switching frequencies, and/or a temperature.

Once the controller 150 obtains the operational condition information within the converter 122, the controller 150 may adjust any of the modulation control attributes (e.g., modulation control parameters, modulation control modes, and/or threshold reactive current) of the converter 122 in order to minimize losses within the converter 122. In this manner, the controller 150 may adjust to any changes in operational condition information, maintaining ZVS and a power level of the converter 122, while minimizing other losses such as losses due to excess reactive current. The controller 150 resolves non-ideal behaviors of the converter 122, which may be manifested as parasitics, especially at higher switching frequencies. The parasitics may include switch capacitances, RDS-on resistances, and parasitic inductances which may increase non-linearities within the converter circuit 220.

The controller 150 may generate, or cause to be generated, separate waveforms that satisfy the modulation control attributes, while maintaining the threshold reactive current to ensure ZVS and minimizing an amount of excess reactive current within the converter 122. The generated waveforms may correspond to full bridge AC waveforms at outputs of the primary bridge and the secondary bridge, and may be used to regulate current flow across different complementary pairs, as will be illustrated in FIG. 2B.

In some embodiments, the controller 150 may determine adjusted modulation control attributes of the converter 122 and transmit the adjusted modulation control attributes to any of the interfaces 241, 245, 251, 255. The interfaces 241, 245, 251, and/or 255 may program any of the drivers 221, 225, 231, and/or 235 consistent with the generated waveforms. In particular, when the generated waveforms indicate that a particular transistor is to be in an ON state during a particular time period, the interfaces 241, 245, 251, and/or 255 may program a corresponding driver to be in an ON state during that particular time period.

The interfaces 241, 245, 251, and 255 may be implemented as the interface 152 of FIG. 1A. Thus, in some embodiments, any tasks that are attributed to the controller 150 may be assigned to one of the interfaces (e.g., the interfaces 241, 245, 251, and 255), and vice versa. The outputs of the interfaces 241, 245, 251 and 255 are synchronized. The synchronization of outputs provides high accuracy in phase-shifted PWM outputs. In some embodiments, the controller 150 and any or all of the interfaces 241, 245, 251, 255, 273, 283, and/or 293, and any other interfaces that the controller 150 communicates with may be combined together to form a controller system.

FIG. 2B is a diagram depicting how waveforms generated by the controller 150 may affect ON and OFF cycles of transistors, consistent with FIGS. 1A-1D and FIG. 2A. In particular, the controller 150 may program modulation control attributes to generate a primary waveform indicated as vₚᵣᵢ, and a secondary waveform indicated as v_{sec}. The modulation control attributes may include, in some embodiments, a duty cycle of the primary waveform, a duty cycle of the secondary waveform, and a phase shift @ between the primary and secondary waveforms. Because current flows from a positive terminal to a negative terminal, whether the value of vₚᵣᵢ is positive or negative indicates which current flow path is open and which current flow path is closed within the primary bridge. Similarly, whether the value of v_{sec} is positive or negative indicates which current flow path is open and which current flow path is closed within the primary bridge.

During a first time period from t=0 to t=t₁, when vₚᵣᵢ is positive, a complementary pair including the transistors 222 and 228 may be in an ON state while a complementary pair including the transistors 226 and 224 may be in an OFF state. During a second time period from t=t₁ to t=t₂, when vₚᵣᵢ is negative, indicating a reversed polarity across an output of the primary bridge, a complementary pair including the transistors 226 and 224 may be in an ON state while a complementary pair including the transistors 222 and 228 may be in an OFF state. Moving to the secondary bridge, during a third time period from t=t₃ to t=t₄, when v_{sec} is positive, a complementary pair including the transistors 232 and 238 may be in an ON state. During a fourth time period from t=t₄ to t=t₅, a complementary pair including the transistors 236 and 234 may be in an ON state.

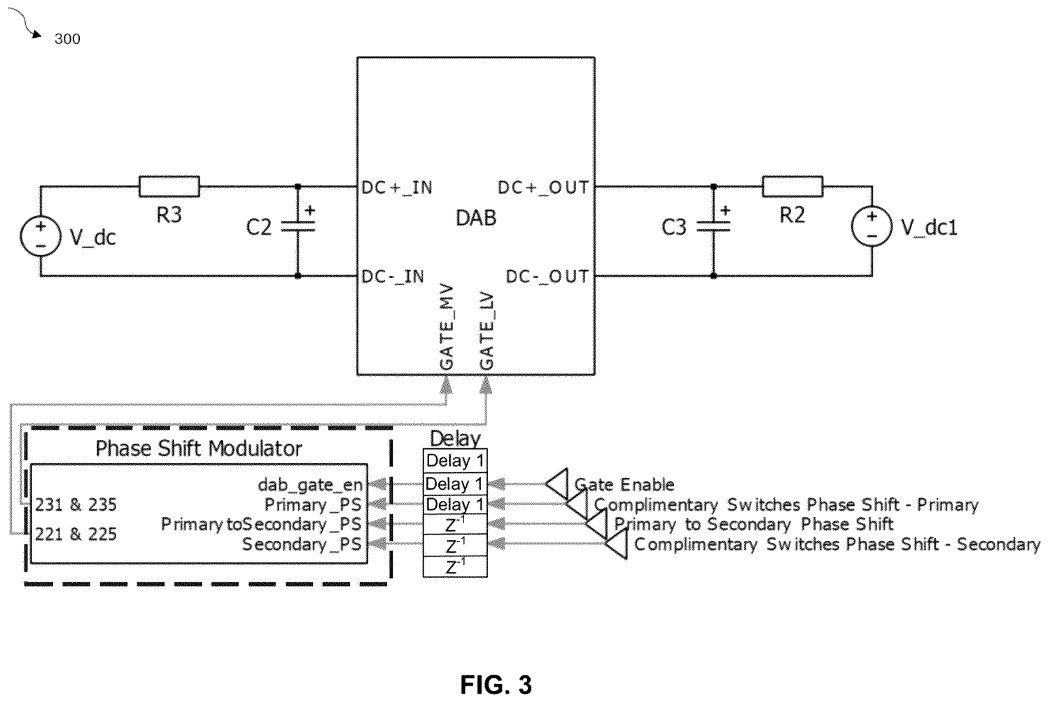

FIG. 3 illustrates an example diagram, consistent with FIGS. 1A, 1B, 1C, 1D, 2A, and 2B. FIG. 3 illustrates a diagram of a phase shift modulator 300 implemented in conjunction with the electric system 100 and/or the electric system 200. In FIG. 3, the phase shift modulator 300 may program gate drivers corresponding to the primary bridge and the secondary bridge. The gate drivers may be implemented in a same or similar manner as any of the drivers 221, 225, 231, and/or 235 of FIG. 2A. Parameters of the phase shift modulator may include any parameters of triple phase shift control, including duty cycles of the primary and secondary bridges and a phase shift between the primary and secondary bridge. The phase shift modulator 300 ensures that the gate drivers are programmed in a consistent manner with the waveforms generated by the controller 150 and/or the modulation control attributes determined by the controller 150. For example, if a waveform indicates that between a given time period, that a particular transistor is in an ON state, a gate driver corresponding to that transistor may also be programmed to maintain an ON state of the transistor during that time period.

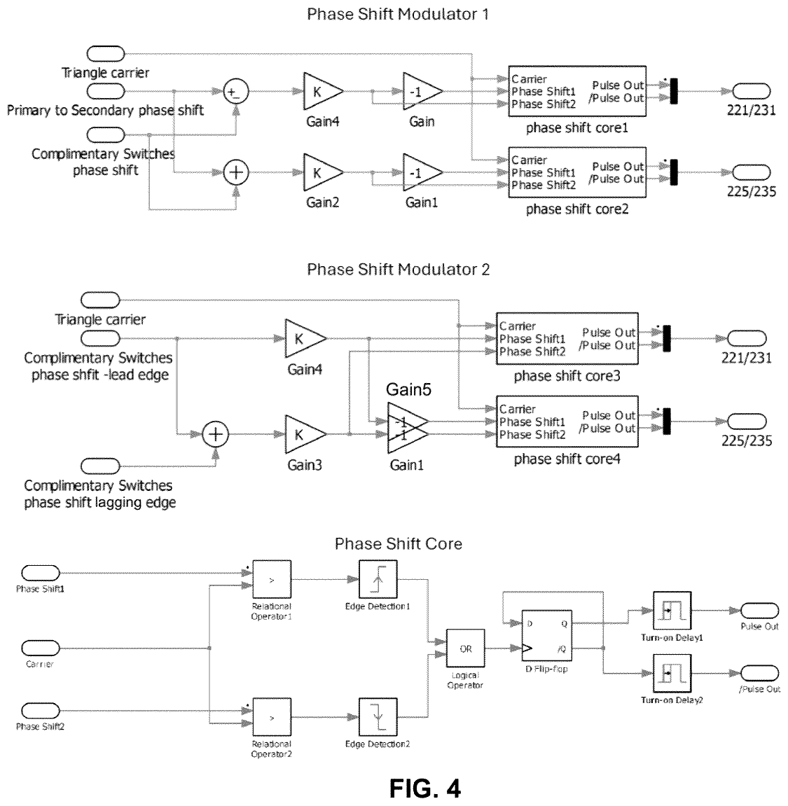

FIG. 4 illustrates an example diagram including logic blocks to implement modulation control attributes, consistent with FIGS. 1A, 1B, 1C, 1D, 2A, and 2B. In particular, FIG. 4 illustrates logic blocks to implement an internal phase shift between complementary pairs of transistors within the secondary bridge, and to implement a phase shift between the primary bridge and the secondary bridge. The phase shift modulator 300 can be implemented using Phase shift modulator 1 or 2, illustrated in FIG. 4, in which both the Phase shift modulator 1 and the Phase shift modulator 2 use same phase shift core logic design. The outputs of 300 may be connected to 221 or 231 and 225 or 235.

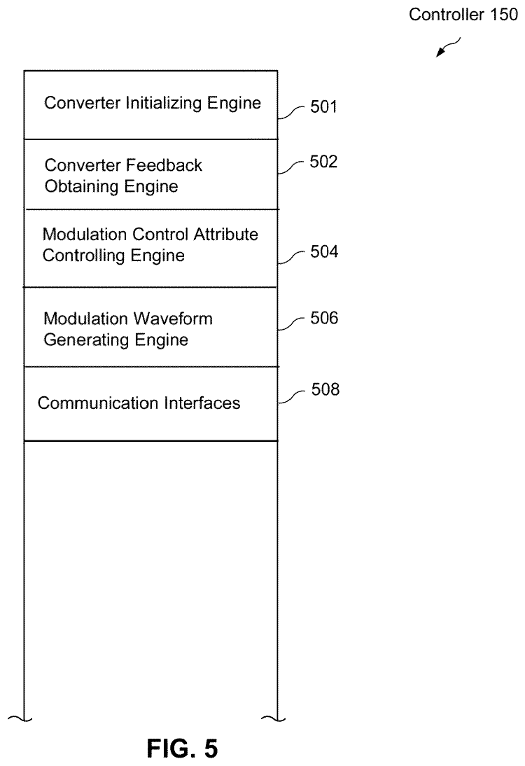

FIG. 5 is a block diagram illustrating details of the controller 150, which coordinates operations of the electric system 100, 200, or 300. For simplicity, operations of FIG. 5 will refer back to FIG. 2A, though FIG. 5 is also relevant to any of the previous and subsequent FIGS.

Any engines referred to may comprise software, hardware, firmware, and/or circuitry to perform and/or coordinate operations. Although engines are described separately to illustrate different concepts, it is contemplated that the engines described separately do not necessarily constitute different or separate physical processors. Rather, any of the engines may be integrated or combined into a single processor.

In some embodiments, the controller 150 includes a converter initializing engine 501, a converter feedback obtaining engine 502, a modulation control attribute controlling engine 504, a modulation waveform generating engine 506, and one or more communication interfaces 508, which may be implemented as any of the interfaces previously described (e.g., the interface 152 of FIG. 1A, and/or the interfaces 241, 245, 251, 255, 273, 283, and/or 293).

The converter initializing engine 501, may program initial modulation control attributes of the converter. The programming of the initial modulation control attributes may be based on characteristics or estimated characteristics of the converter. These characteristics may include any of an input voltage, a nominal output voltage, a nominal power, a switching frequency, a load, an inductance, an output capacitance, a voltage gain, and/or a transformer turn ratio of the converter. The modulation control attributes of the converter may include duty cycles of different bridges of the converter, a phase shift between different bridges, phase shifts between different complementary pairs of switches within a bridge, and/or an operation or modulation control mode. For example, as shown in FIG. 1B, the converter initializing engine 501 may set initial modulation control attributes, including a duty cycle of a primary bridge of the converter 122, denoted as d₁, a duty cycle of a secondary bridge of the converter 122, denoted as d₂, and a phase shift between the primary bridge and the secondary bridge, denoted as q. In some embodiments, additionally or alternatively, other initial modulation control attributes may include a phase shift between complementary pairs of switches within the primary bridge, a phase shift between complementary pairs of switches within the secondary bridge, and/or the threshold reactive current. The modulation control attributes may include pulse width modulation (PWM) attributes. In some embodiments, the modulation control attributes may include a threshold reactive current. A modulation control mode may correspond to a specific phase shift technique, such as SPS and/or TPS.

The converter feedback obtaining engine 502 may obtain feedback from the converter 122 and/or from the sensors 123 of FIGS. 1A and/or 2A. The feedback may include or indicate any operational condition of the converter 122. For example, the feedback may indicate an environmental condition, such as temperature measured within the switches of the converter 122. Additionally or alternatively, the feedback may indicate an electric attribute such as a load level, power level, voltage gain, amount of excess reactive energy or excess reactive current, and/or switching frequency, output voltage and/or an output power of the converter 122. The converter feedback obtaining engine 502 may receive feedback regarding one or more operational conditions within the converter 122, via communication with the one or more sensors and/or interfaces, including the one or more sensors 123, one or more sensors 263, and/or interfaces 273, 283, and/or 293, as illustrated in FIG. 2A. The operational conditions may include or be obtained or derived from any or all of sensor data, changes in any characteristics, state information, status updates, imperfections, and/or deviations from initial characteristics, such as additional cables or wiring within the converter.

The modulation control attribute controlling engine 504 may adaptively and/or iteratively adjust the modulation control attributes depending on different operational conditions of the converter, such as a load level, power level, voltage gain, amount of excess reactive energy or excess reactive current, switching frequencies, and/or a temperature. For example, the modulation control attribute controlling engine 504 may iteratively adjust the threshold reactive current until a fluctuation of temperature is minimized, or falls to below a threshold level of fluctuation. Additionally, the modulation control attribute controlling engine 504 may adjust the modulation control attributes based on the iteratively adjusted threshold reactive current, and/or a power outputted by the converter 122. By iterative and adaptive controlling of the modulation control attributes of the converter, the modulation control attribute controlling engine 504 maintains zero voltage switching (ZVS) within switches of the converter while maintaining an amount of power delivered by the converter. The modulation control attribute controlling engine 504 maintains ZVS by maintaining a threshold level of reactive current that is used to sufficiently charge and/or discharge a voltage, current, and/or capacitance, such as an output capacitance across capacitors connected through the switches. The modulation control attribute controlling engine 504 also minimizes excess reactive energy or excess reactive current within the converter. Therefore, the modulation control attribute controlling engine 504 increases efficiency of the converter by maintaining ZVS to prevent or reduce switching losses and by reducing excess reactive energy or excess reactive current within the converter.

The modulation waveform generating engine 506 may generate waveforms for primary and secondary bridges according to the adjusted modulation control attributes. The waveforms may be implemented as full bridge output AC waveforms, which include a primary waveform indicated as vₚᵣᵢ, and a secondary waveform indicated as v_{sec} as illustrated in FIG. 2A. The waveforms may be used to regulate current flow across different complementary pairs, as illustrated in FIG. 2B.

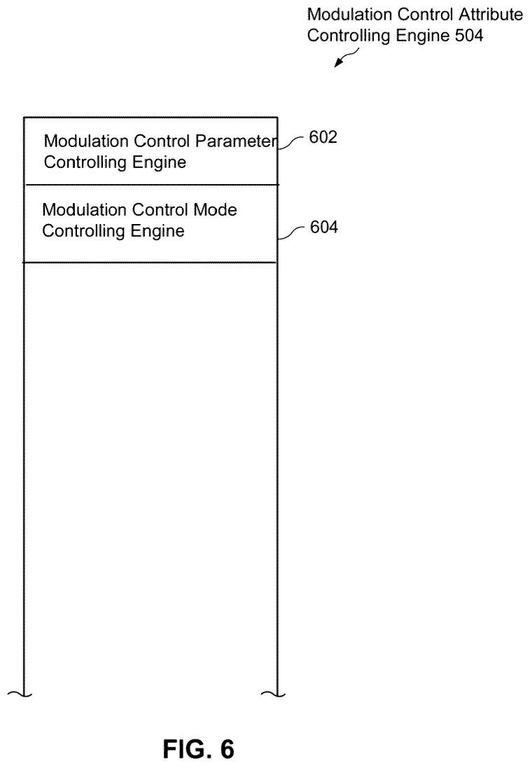

FIG. 6 is a block diagram illustrating details of the modulation control attribute controlling engine 504, which includes a modulation control parameter controlling engine 602 and a modulation control mode controlling engine 604. The modulation control parameter controlling engine 602 may iteratively adjust any modulation control parameters. The modulation control parameters may include, in some embodiments, a threshold reactive energy. The modulation control mode controlling engine 604, in some embodiments, may iteratively adjust the threshold reactive energy based on the temperature measured within switches of the converter 122. For example, the modulation control mode controlling engine 604 may iteratively adjust the threshold reactive energy until a fluctuation in temperature becomes less than a threshold level of fluctuation. The modulation control parameters may further include any of duty cycles of the primary bridge and the secondary bridge, a phase shift between the primary bridge and the secondary bridge, a phase shift between complementary pairs of switches on the primary bridge, and/or a phase shift between complementary pairs of switches on the secondary bridge. In some embodiments, the modulation control mode controlling engine 604 may iteratively adjust any of the aforementioned modulation control parameters based on the threshold reactive energy and/or a power outputted by the converter 122. For example, the modulation control mode controlling engine 604 may adjust attributes to satisfy a ZVS condition as well as a minimum power output, while minimizing an amount of excess reactive energy.

The modulation control mode controlling engine 604 may iteratively adjust between modulation control modes, which correspond to phase shift techniques. The modulation control modes refer to shapes, profiles, or characteristics of modulated waveforms generated by the controller. In a SPS modulation control mode, square wave voltages have same duty cycles for both primary and secondary bridges. A TPS modulation control mode may include two additional degrees of freedom. These two additional degrees of freedom correspond to phase shifts of complementary pairs of switches on both the primary and secondary bridges. In a TPS modulation control mode, duty cycles of the primary bridges and the secondary bridges may be different. In some embodiments, the modulation control mode controlling engine 604 may adjust one or more of the modulation control modes depending on a power level of the converter. For example, if a power level of the converter is above a first threshold power, the controller may set a modulation control mode of the converter to a SPS modulation control mode. If the power level of the converter is at or below the first threshold power, the controller may set a TPS modulation control mode for the converter. In other embodiments, if a power level of the converter is between a first threshold power and a second threshold power, the modulation control mode controlling engine 604 may set a modulation control mode of the converter to a SPS modulation control mode. If the power level of the converter is below the first threshold power or above the second threshold power, the modulation control mode controlling engine 604 may set the modulation control mode to a TPS modulation control mode. In some embodiments, the first threshold power may be between 4 kilowatts (kW) and 5 kW. In some embodiments, the second threshold power may be between 6 kW and 12 kW.

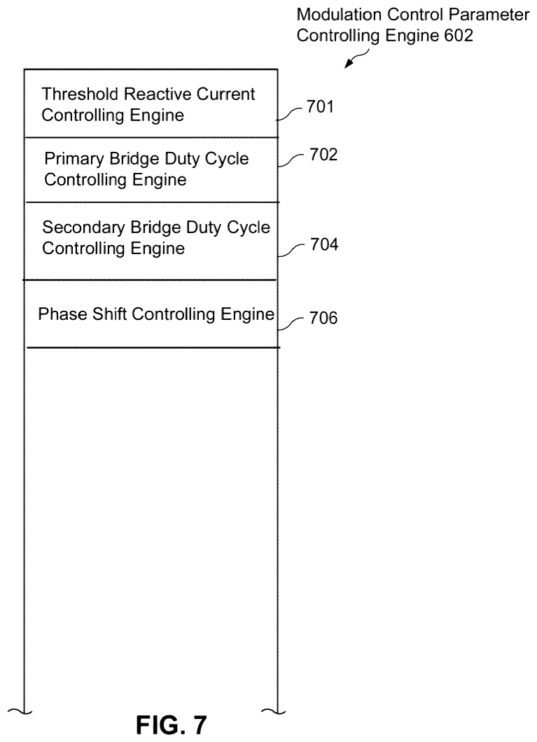

FIG. 7 is a block diagram illustrating details of the modulation control parameter controlling engine 602, which includes a threshold reactive current controlling engine 701, a primary bridge duty cycle controlling engine 702, a secondary bridge duty cycle controlling engine 704, and a phase shift controlling engine 706. The threshold reactive current controlling engine 701 may adjust a threshold reactive current, indicative of a minimum reactive current level within the converter 122 in order to maintain soft switching, such as ZVS. In some embodiments, the threshold reactive current controlling engine 701 may iteratively adjust the threshold reactive current until a temperature fluctuation is minimized and/or falls below a threshold level of fluctuation. In some embodiments, the threshold reactive current controlling engine 701 may otherwise adjust the threshold reactive current based on the temperature. In some embodiments, the threshold reactive current controlling engine 701 may counteract an increase in temperature by changing the threshold reactive current. For example, the threshold reactive current controlling engine 701 may decrease the threshold reactive current in response to a temperature increase.

The primary bridge duty cycle controlling engine 702 may adjust a duty cycle of an output AC waveform corresponding to the primary bridge. The primary bridge, in FIG. 2A, includes the transistors 222, 224, 226, 228. In some embodiments, the primary bridge duty cycle controlling engine 702 may adjust the duty cycle in response to operational conditions such as an increase in temperature, an excess amount of reactive current within the converter, and/or a power output of the converter. For example, if the temperature within the converter has increased, the primary bridge duty cycle controlling engine 702 may decrease the duty cycle in order to decrease the temperature. If an excess amount of reactive current within the converter exceeds a threshold, the primary bridge duty cycle controlling engine 702 may decrease the duty cycle. Thus, a change in the threshold reactive current, made by the threshold reactive current controlling engine 701, may result in a decrease in the duty cycle. If the output power generated by the converter fails to satisfy a threshold power level, then the primary bridge duty cycle controlling engine 702 may increase a duty cycle.

The secondary bridge duty cycle controlling engine 704 may adjust a duty cycle of an output AC waveform corresponding to the secondary bridge. In FIG. 2A, the secondary bridge includes the transistors 232, 234, 236, and 238. Principles of operation of the secondary bridge duty cycle controlling engine 704 may be similar or same as those of the primary bridge duty cycle controlling engine 702. The phase shift controlling engine 706 may control a phase shift between output voltages of the primary bridge and the secondary bridge (e.g., vₚᵣᵢ and v_{sec} in FIG. 2A). Additionally or alternatively, the phase shift controlling engine 706 may control a phase shift between complementary pairs of switches within the primary bridge (e.g., a pair of transistors including 222 and 228, and a pair of transistors including 226 and 224) and/or a phase shift between complementary pairs of switches within the secondary bridge (e.g., a pair of transistors including 232 and 238, and a pair of transistors including 236 and 234).

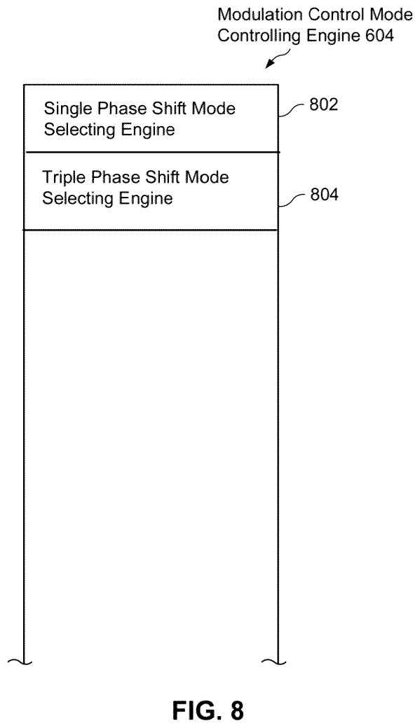

FIG. 8 is a block diagram illustrating details of the modulation control mode controlling engine 604, which includes a single-phase shift mode selecting engine 802 and a triple phase shift mode selecting engine 804. In some embodiments, the single-phase shift (SPS) mode selecting engine 802 may select a SPS modulation control mode to be implemented under certain scenarios. These scenarios may include when the converter is operating at certain power levels. For example, if a power level of the converter is above a first threshold power, the controller may set a modulation control mode of the converter to a SPS modulation control mode. If the power level of the converter is at or below the first threshold power, the controller may set a TPS modulation control mode for the converter. In other examples, if a power level of the converter is between a first threshold power and a second threshold power, the SPS mode selecting engine 802 may set a modulation control mode of the converter to a SPS modulation control mode. In some embodiments, the first threshold power may be between 4 kilowatts (kW) and 5 kW. In some embodiments, the second threshold power may be between 6 kW and 12 kW. In some embodiments, the triple phase shift (TPS) mode selecting engine 804 may select a SPS modulation control mode to be implemented under certain scenarios. These scenarios may include when the converter is operating at certain power levels. For example, if a power level of the converter is below the first threshold power and or above the second threshold power, the TPS selecting engine 804 may set a modulation control mode of the converter to a TPS modulation control mode. In some embodiments, the TPS mode selecting engine 804 may select a TPS mode in response to ZVS being unmet within the converter.

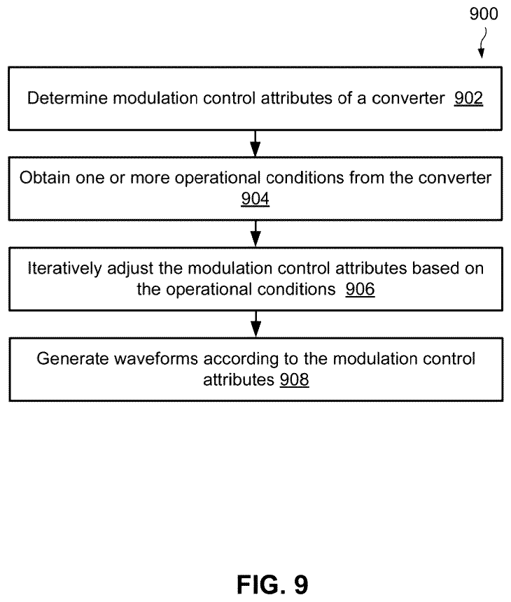

FIG. 9 is a flowchart of a method 900 of controlling an operation of a converter, as implemented within an electric system (e.g., the electric system 100 of FIG. 1A, the electric system 200 of FIG. 2A, or the electric system 300 of FIG. 3 in different embodiments). In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

Method 900 begins with step 902, in which one or more processors (e.g., the controller 150, in particular, the converter initializing engine 501, determines one or more modulation control attributes of a converter. The modulation control attributes may include any of duty cycles of different bridges of the converter, a phase shift between different bridges, phase shifts between different complementary pairs of switches within a bridge, and/or a modulation control mode corresponding to one or more phase shift techniques (e.g., SPS, TPS). The modulation control attributes may be based on characteristics or estimated characteristics of the converter. These characteristics may include any of an input voltage, a nominal output voltage, a nominal power, a switching frequency, a load, an inductance, an output capacitance, a voltage gain, and/or a transformer turn ratio of the converter.

In step 904, one or more processors (e.g., the converter feedback obtaining energy 502) may obtain feedback from the converter 122 and/or from the sensors 123 of FIGS. 1A and/or 2A. The feedback may include or indicate any operational condition information of the converter 122. The operational condition information corresponds to a component within the converter, the converter as a whole, or an output of the converter. For example, the feedback may indicate an environmental condition, such as temperature measured within the switches of the converter 122. Additionally or alternatively, the feedback may indicate an electric attribute such as a load level, power level, voltage gain, amount of excess reactive energy or excess reactive current, and/or switching frequency, output voltage and/or an output power of the converter 122.

In step 906, one or more processors (e.g., the modulation control attribute controlling engine 504) may iteratively adjust one or more of the modulation control attributes based on the feedback received in step 904. In some embodiments, the modulation control attribute controlling engine 504 may iteratively adjust one or more of the modulation control attributes to maintain at least a threshold level of power output, maintain ZVS within the switches, and/or minimize or reduce an amount of excess reactive current, beyond the threshold reactive current required to maintain ZVS.

In step 908, one or more processors (e.g., the modulation waveform generating engine 508) may generate waveforms corresponding to the primary and secondary bridges. The generated waveforms may have the modulation control attributes, and may include a primary waveform implemented as vₚᵣᵢ, and a secondary waveform indicated as v_{sec} as illustrated in FIG. 2A. In some embodiments, the modulation waveform generating engine 508 may continuously generate waveforms. Therefore, whenever any of the modulation control attributes have changed, a new waveform that has the most recent modulation control attributes is generated.

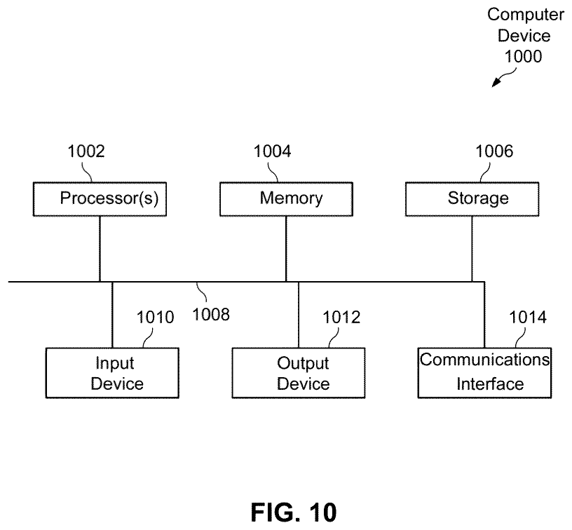

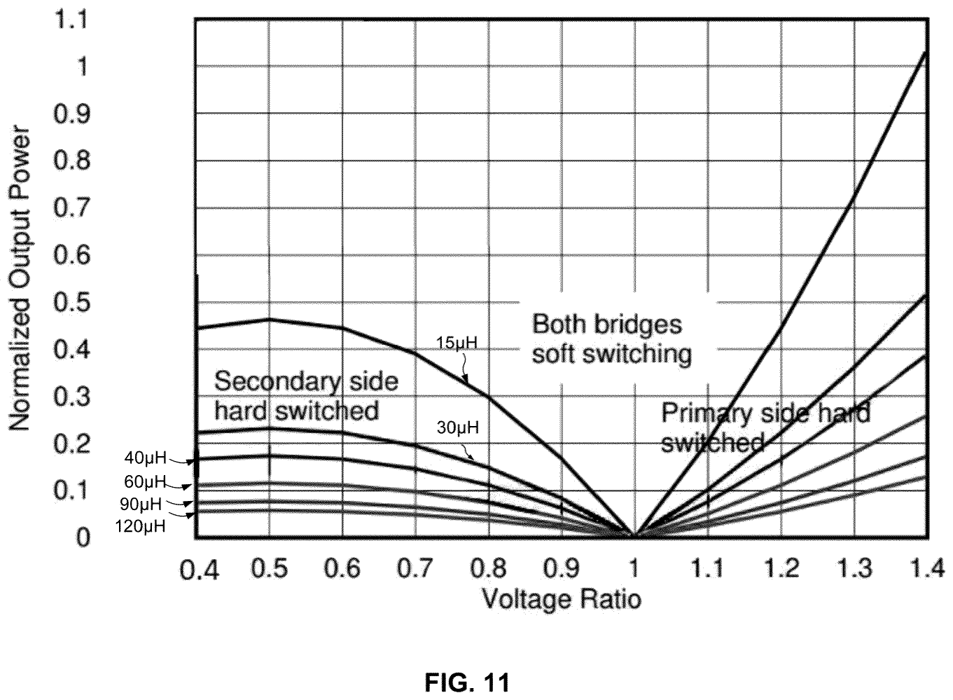

FIG. 10 is a block diagram of a computing system 1000. Any of the controller 150 and/or engines described herein may comprise an instance of one or more computing systems 1000. In some embodiments, functionality of the computing system 1000 is improved to perform some or all of the functionality described herein. The computing system 1000 comprises a processor 1002, memory 1004, storage 1006, an input device 1010, a communication network interface 1014, and an output device 1012 communicatively coupled to a communication channel 1008. The processor 1002 is configured to execute executable instructions (e.g., programs), and may be implemented as the controller 160. In some embodiments, the processor 1002 comprises circuitry or any processor capable of processing the executable instructions.

The memory 1004 stores data. Some examples of memory 1004 include storage devices, such as RAM, ROM, RAM cache, virtual memory, etc. In various embodiments, working data is stored within the memory 1004. The data within the memory 1004 may be cleared or ultimately transferred to the storage 1006.

The storage 1006 includes any storage configured to retrieve and store data. Some examples of the storage 1006 include flash drives, hard drives, optical drives, cloud storage, and/or magnetic tape. In some embodiments, storage 1006 may include RAM. Each of the memory 1004 and the storage 1006 comprises a computer-readable medium, which stores instructions or programs executable by processor 1002.

The input device 1010 may be any device that inputs data (e.g., mouse and keyboard). The output device 1012 may be any device that outputs data and/or processed data (e.g., a speaker or display). It will be appreciated that the storage 1006, input device 1010, and output device 1012 may be optional. For example, the routers/switchers may comprise the processor 1002 and memory 1004 as well as a device to receive and output data (e.g., the communication network interface 1014 and/or the output device 1012).

The communication network interface 1014 may be coupled to a network (e.g., the network 162) via the link 1008. The communication network interface 1014 may support communication over an Ethernet connection, a serial connection, a parallel connection, and/or an ATA connection. The communication network interface 1014 may also support wireless communication (e.g., 802.11 a/b/g/n, WiMax, LTE, WiFi). It will be apparent that the communication network interface 1014 may support many wired and wireless standards.

It will be appreciated that the hardware elements of the computing system 1000 are not limited to those depicted. A computing system 1000 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1002 and/or a co-processor located on a GPU (i.e., NVidia).

It will be appreciated that an “engine,” “system,” “datastore,” and/or “controller” may comprise software, hardware, firmware, and/or circuitry. In one example, one or more software programs comprising instructions capable of being executable by a processor may perform one or more of the functions of the engines, systems, datastores, and/or controller described herein. In another example, circuitry may perform the same or similar functions. Alternative embodiments may comprise more, less, or functionally equivalent engines, systems, datastores, or databases, and still be within the scope of present embodiments. For example, the functionality of the various engines, systems, datastores, and/or controller may be combined or divided differently. The datastores may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or controller described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. References to “approximately” may be construed to encompass values within a certain range of the specified value, such as within 25 percent, 10 percent, 5 percent, 1 percent, 0.5 percent, 0.25 percent, 0.1 percent, or any other applicable value. For example, unity voltage gain may refer to voltage ratios between primary and secondary bridges that are approximately one. In other embodiments, “approximately” may refer to a value or entity being within a design tolerance to achieve an objective or result. For example, an approximately unity voltage may refer to a design level of efficiency to maintain a certain level of soft switching (e.g., ZVS) and/or to limit switching losses within some range.

Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

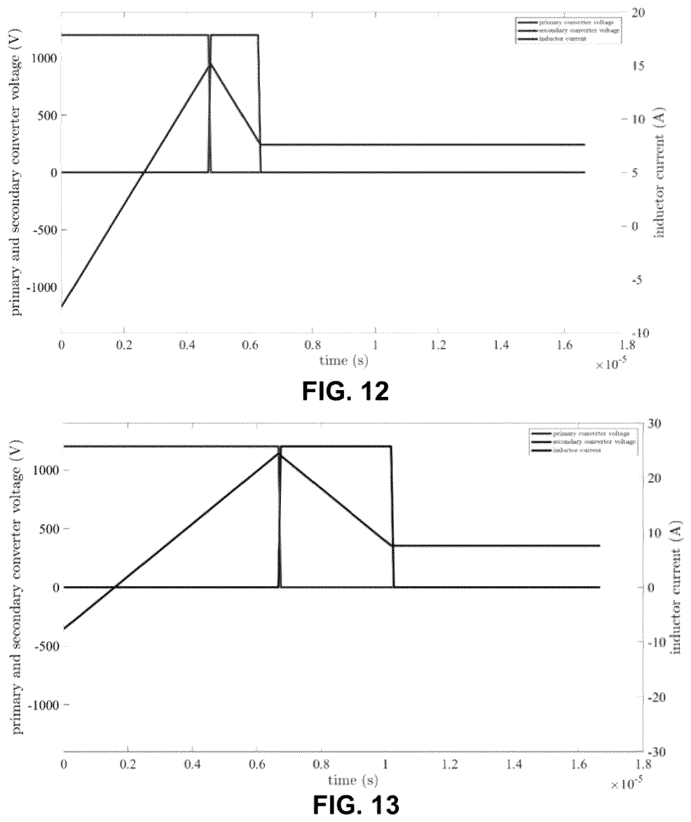

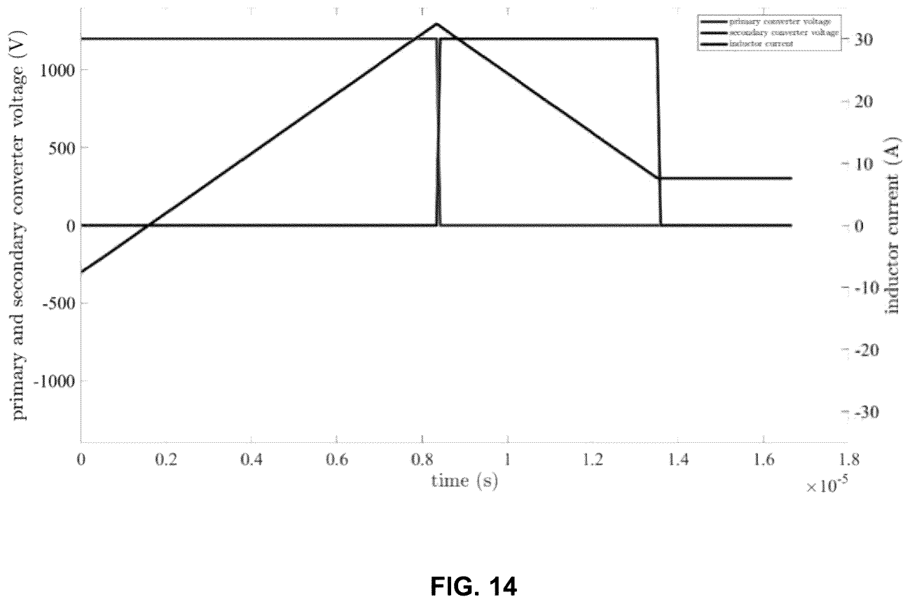

FIGS. 12-14 illustrate diagrams showing converter voltage waveforms and inductor currents under different duty cycles, utilizing a TPS modulation control mode with a non-overlapping mode of converter voltages. The inductor currents in FIGS. 12-14 are triangular. A minimum duty ratio of the primary bridge, d₁ is maintained to provide the necessary reactive current. Here, the relationships between the duty cycle d₁ for the primary bridge, the duty cycle d₂ for the secondary bridge, the minimum duty cycle d₁ₘᵢₙ of the primary bridge, characteristics of the converter, and phase shift phi are given by the following:

$$d {1}_{min} < d 1 < 0.25$$

$$d {1}_{min} = \frac{{21}_{min} {L}_{ext}}{\text{?} V \text{?}}$$

$$d 2 = d 1 - d {1}_{min}$$

$$phi = d 1 - \frac{d {1}_{min}}{2}$$

$$\text{?} \text{indicates text missing or illegible when filed}$$

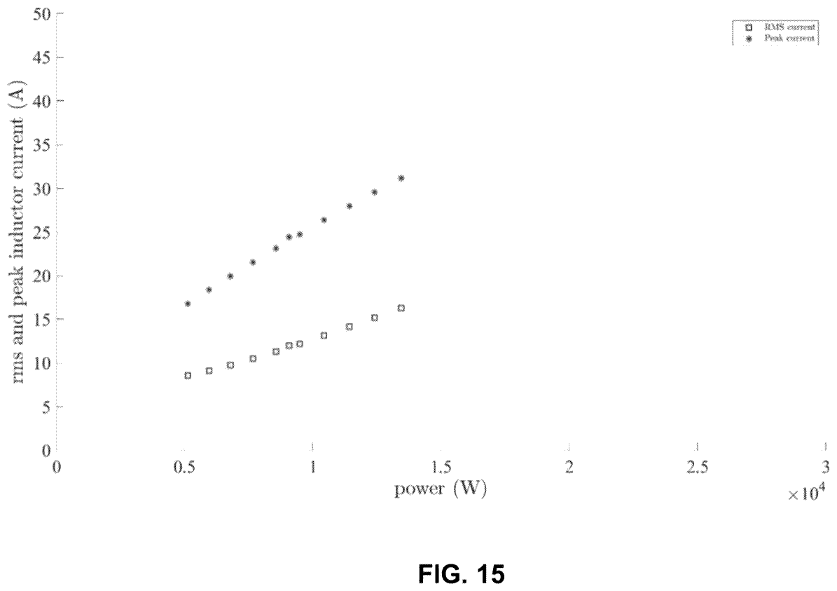

FIG. 15 illustrates root mean square (RMS) current and peak current levels within the transformer, using a non-overlapping converter voltage waveform at various duty cycles, consistent with FIGS. 12-14.

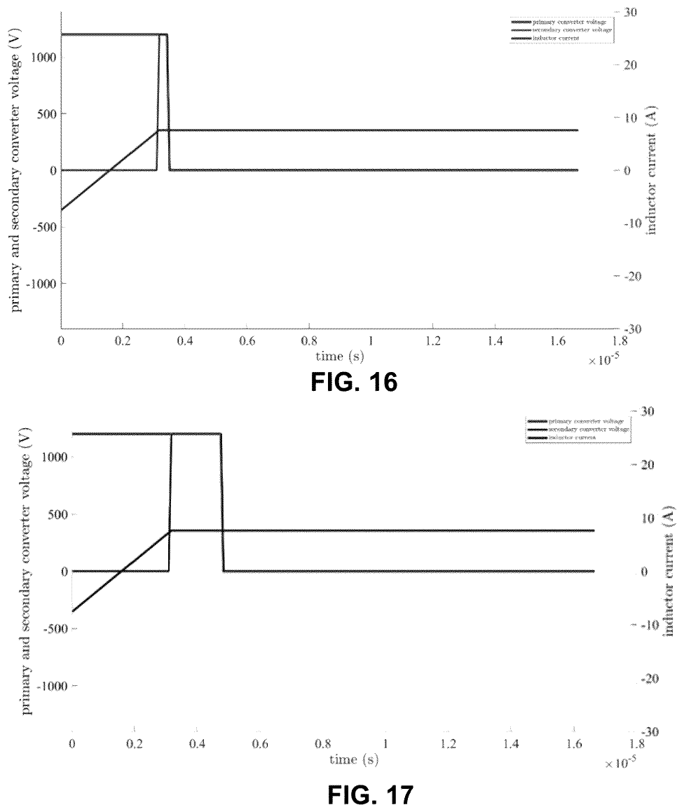

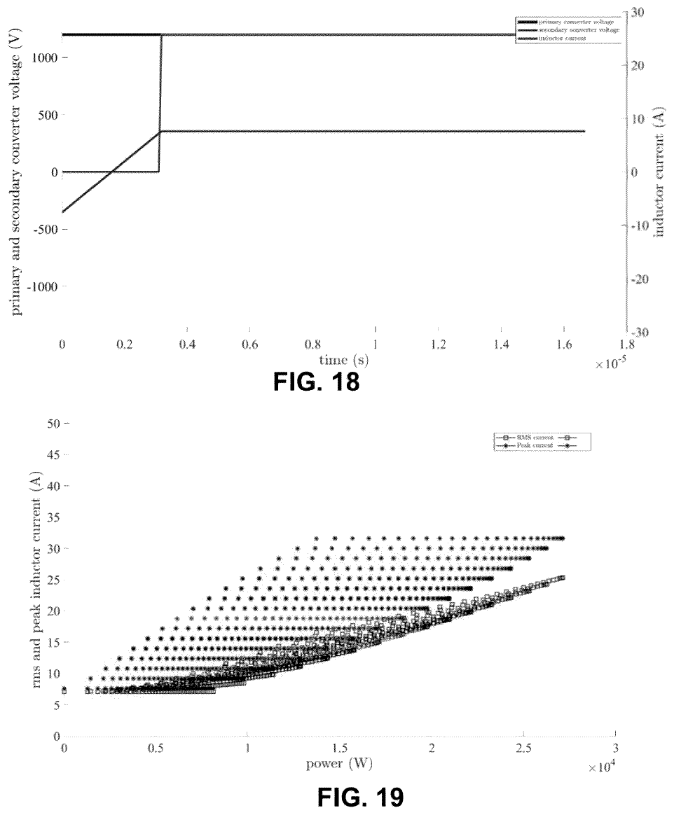

FIGS. 16-18 illustrate diagrams showing converter voltage waveforms and inductor currents under different duty cycles, utilizing a TPS modulation control mode with an overlapping mode of converter voltages. During the overlapping voltage period between the primary and secondary bridges, the inductor current does not increase and power is transferred from the primary bridge to the secondary bridge. The inductor current exhibits a trapezoidal relationship over time.

FIG. 19 illustrates RMS current and peak current levels within the transformer, using an overlapping converter voltage waveform at various duty cycles, consistent with FIGS. 16-18.

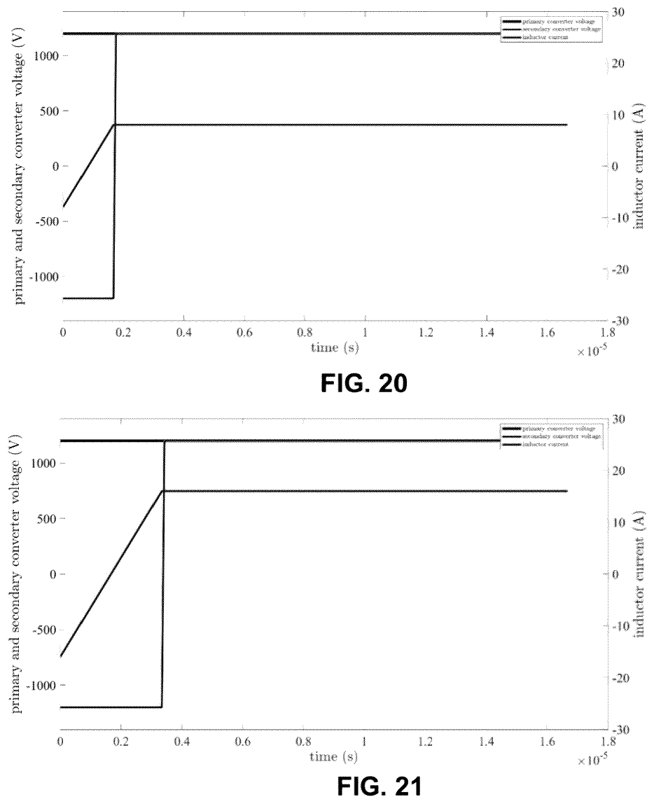

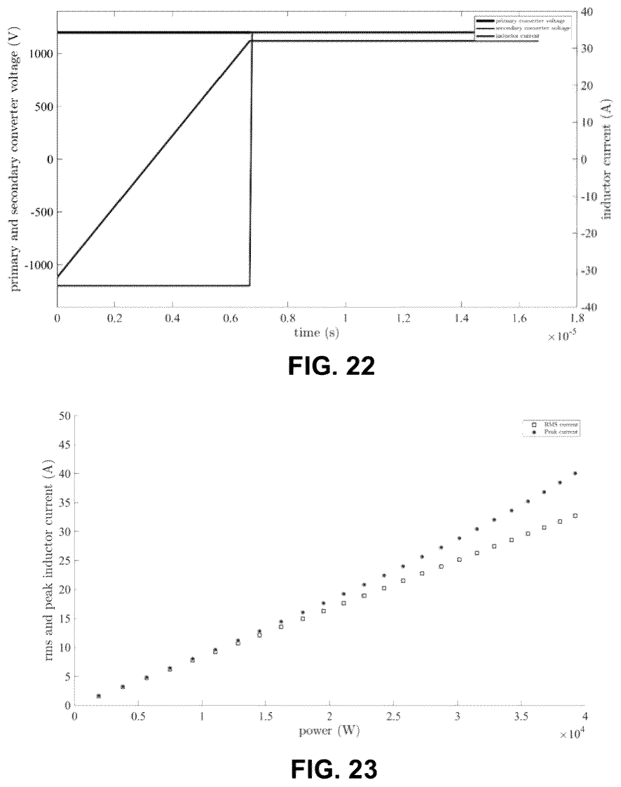

FIGS. 20-22 illustrate diagrams showing converter voltage waveforms and inductor currents under different duty cycles, utilizing a SPS modulation control mode. FIG. 23 illustrates RMS current and peak current levels within the transformer, using a SPS modulation control mode, consistent with FIGS. 20-22.

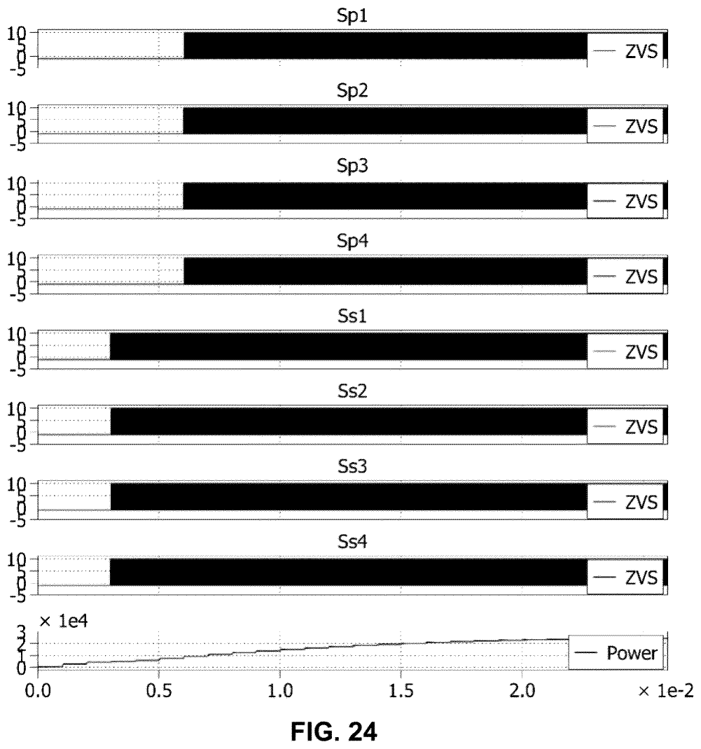

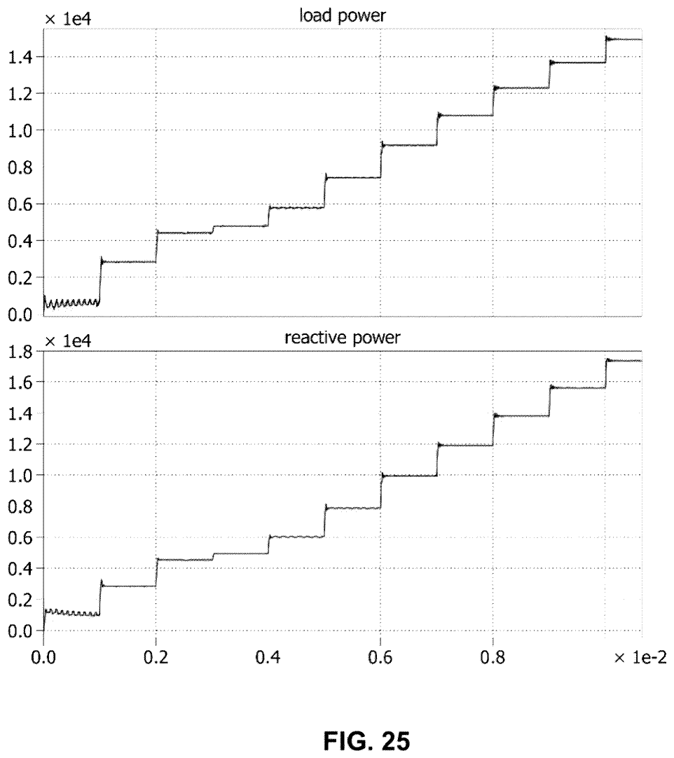

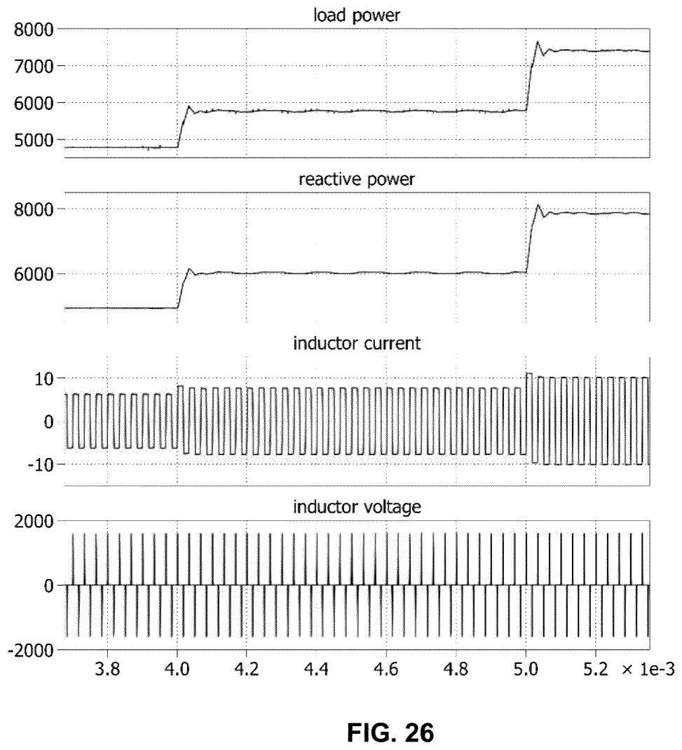

FIG. 24 illustrates ZVS regions of switches utilizing a SPS modulation control mode. FIG. 25 illustrates delivered load power and reactive power when a SPS modulation control mode is utilized, consistent with FIGS. 20-23. FIG. 26 illustrates inductor current and inductor voltage when a SPS modulation control mode is utilized.

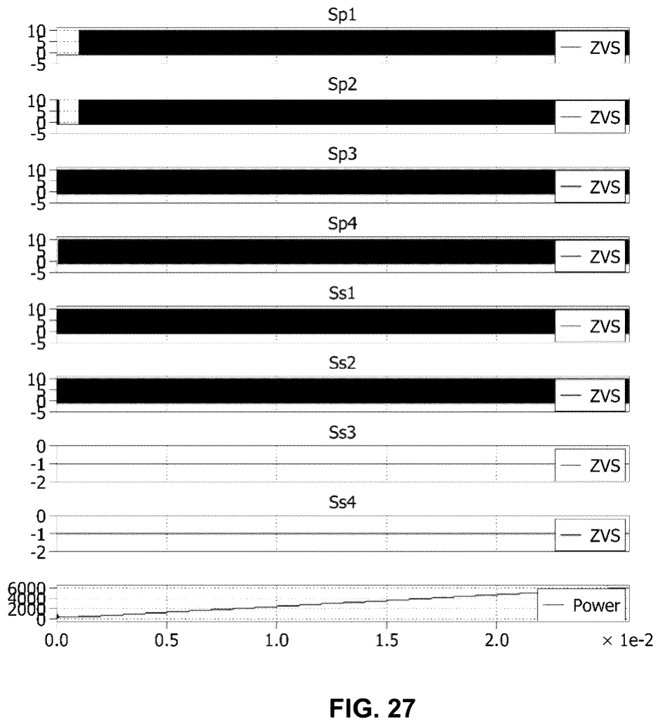

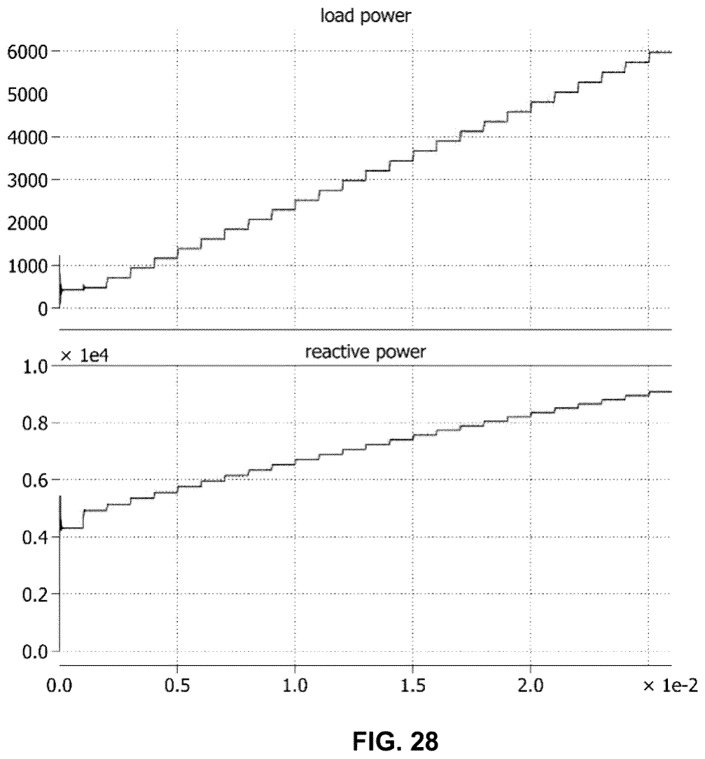

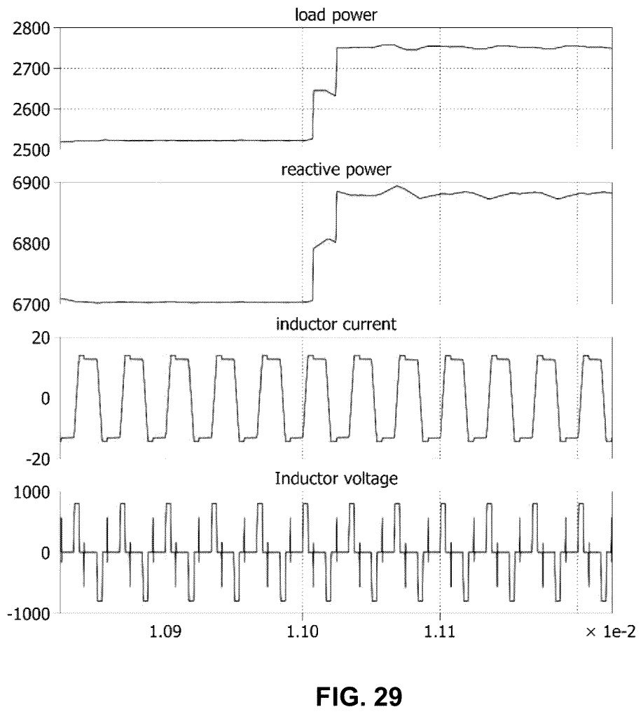

FIG. 27 illustrates ZVS regions of switches utilizing a TPS modulation control mode. FIG. 28 illustrates delivered power and reactive power in a circuit utilizing an overlapping converter voltage waveform. FIG. 29 illustrates inductor current and inductor voltage when a TPS modulation control mode is utilized.

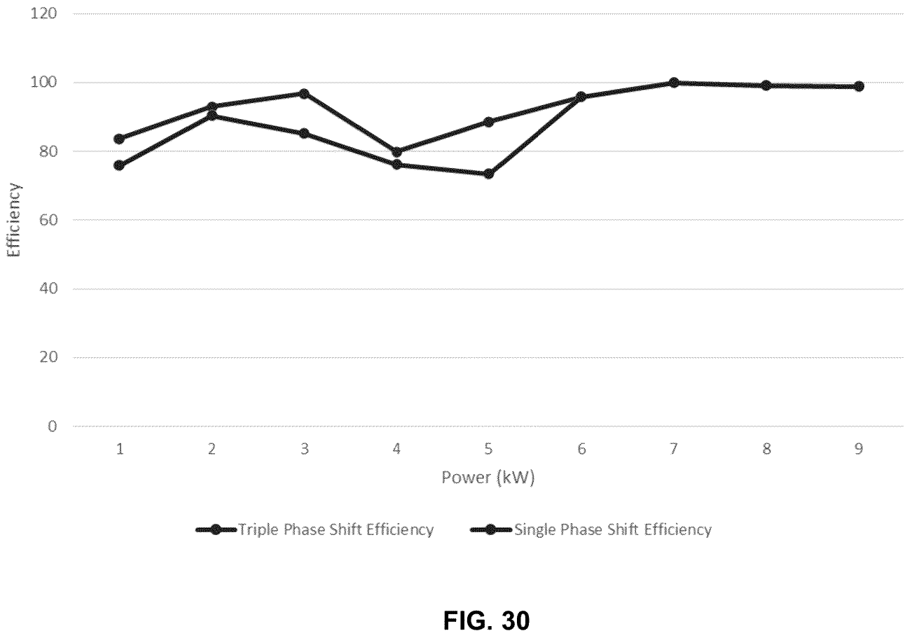

FIG. 30 illustrates a comparison of efficiencies at different power levels, comparing a TPS modulation control mode and a SPS modulation control mode.

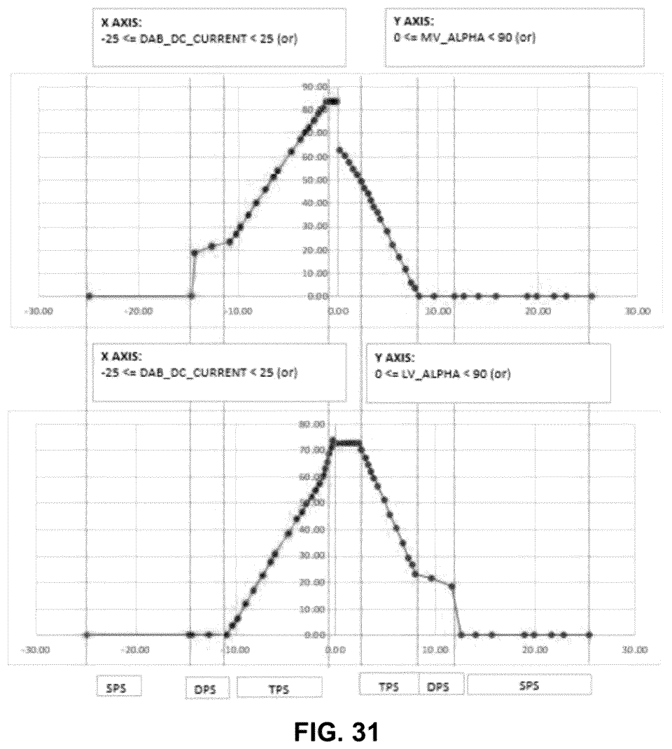

FIG. 31 illustrates a relationship between current outputted by the converter using different modulation control modes, including a SPS, DPS, and a TPS modulation control mode, for both the primary and secondary bridges.

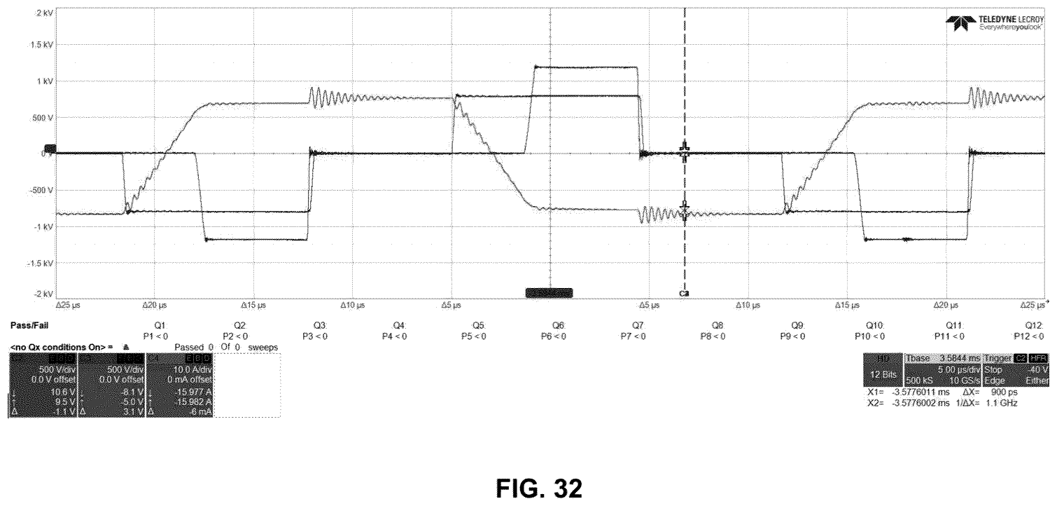

FIG. 32 illustrates a relationship of voltages over time across different switches over time.

1. A system for controlling a converter, the system comprising:
a converter configured to distribute electric energy from an energy source to a load, the converter comprising a dual active bridge (DAB); and
a controller system comprising:
one or more interfaces configured to communicate with the converter; and
a controller, the controller system further comprising:
one or more hardware processors; and
memory storing computer instructions, the computer instructions when executed by the one or more hardware processors configured to perform:
determining modulation control attributes based on characteristics of the converter, the modulation control attributes comprising one or more modulation control parameters and one or more modulation control modes corresponding to one or more phase shift techniques;
obtaining operational condition information within the converter, the operational condition information corresponding to a component within the converter or an output of the converter;
iteratively adjusting the modulation control attributes based on the operational condition information; and
controlling the converter based on the iteratively adjusted modulation control attributes.

2. The system of claim 1, wherein the controlling of the converter comprises generating one or more modulation waveforms according to the iteratively adjusted modulation control attributes, the one or more modulation waveforms being implemented as full bridge output alternating current (AC) waveforms on primary and secondary bridges of the converter.

3. The system of claim 1, wherein the converter comprises a primary bridge and a secondary bridge; and the modulation control attributes comprise any of a phase shift between an output voltage of the primary bridge and an output voltage of the secondary bridge, a duty cycle of the primary bridge, and a duty cycle of the secondary bridge.

4. The system of claim 1, wherein the generating of the one or more waveforms comprises generating a primary waveform and a secondary waveform, the primary waveform at least partially overlapping with the secondary waveform.

5. The system of claim 1, wherein the iteratively controlling or adjusting of the modulation control attributes comprises adjusting a threshold reactive current level within the converter based on the temperature or a change in the temperature.

6. The system of claim 5, wherein the iteratively controlling or adjusting of the modulation control attributes comprises adjusting a modulation control mode of the converter based on a comparison between an amount of reactive current within the converter and the threshold reactive current level.

7. The system of claim 6, wherein the adjusting of the modulation control mode comprises:
in response to the amount of reactive current within the converter failing to satisfy the threshold reactive current level, adjusting from a single-phase shift (SPS) mode to a triple phase shift (TPS) mode.

8. The system of claim 1, wherein the converter operates under approximately unity voltage gain.

9. The system of claim 1, wherein the iteratively controlling or adjusting the modulation control attributes comprises adjusting the modulation control attributes based on voltages measured across one or more switches of the converter.

10. The system of claim 1, wherein the iteratively controlling or adjusting the modulation control attributes comprises adjusting the modulation control attributes based on a power level of the converter.

11. A method implemented by a controller system within an electric system, the electric system comprising a converter configured to distribute electric energy from an energy source to a load, the converter comprising a dual active bridge (DAB); and
the controller system comprises a controller and one or more interfaces coupled to and communicating with the converter, the method comprising:
determining modulation control attributes based on characteristics of the converter, the modulation control attributes comprising one or more modulation control parameters and one or more modulation control modes corresponding to one or more phase shift techniques;
obtaining operational condition information within the converter, the operational condition information corresponding to a component within the converter or an output of the converter;
iteratively adjusting the modulation control attributes based on the operational condition information; and
controlling the converter based on the iteratively adjusted modulation control attributes.

12. The method of claim 11, wherein the controlling of the converter comprises generating one or more modulation waveforms according to the iteratively adjusted modulation control attributes, the one or more modulation waveforms being implemented as full bridge output alternating current (AC) waveforms on primary and secondary bridges of the converter.

13. The method of claim 11, wherein the converter comprises a primary bridge and a secondary bridge; and the modulation control attributes comprise any of a phase shift between an output voltage of the primary bridge and an output voltage of the secondary bridge, a duty cycle of the primary bridge, and a duty cycle of the secondary bridge.

14. The method of claim 11, wherein the generating of the one or more waveforms comprises generating a primary waveform and a secondary waveform, the primary waveform at least partially overlapping with the secondary waveform.

15. The method of claim 11, wherein the iteratively controlling or adjusting of the modulation control attributes comprises adjusting a threshold reactive current level within the converter based on the temperature or a change in the temperature.

16. The method of claim 15, wherein the iteratively controlling or adjusting of the modulation control attributes comprises adjusting a modulation control mode of the converter based on a comparison between an amount of reactive current within the converter and the threshold reactive current level.

17. The method of claim 16, wherein the adjusting of the modulation control mode comprises:
in response to the amount of reactive current within the converter failing to satisfy the threshold reactive current level, adjusting from a single-phase shift (SPS) mode to a triple phase shift (TPS) mode.

18. The method of claim 11, wherein the converter operates under approximately unity voltage gain.

19. The method of claim 11, wherein the iteratively controlling or adjusting the modulation control attributes comprises adjusting the modulation control attributes based on voltages measured across one or more switches of the converter.

20. The method of claim 11, wherein the iteratively controlling or adjusting the modulation control attributes comprises adjusting the modulation control attributes based on a power level of the converter.
